(19) United States
(12) Patent Application Publication
(10) Pub. No.: US 2010/0174739 A1
(43) Pub. Date: Jul. 8, 2010

(54) System and Method for Wikifying Content for Knowledge Navigation and Discovery

(76) Inventors: Albert Mons, Gaithersberg, MD (US); Nickolas Barris, Gaithersburg, MD (US); Christine Chichester, Geneva (CH); Barend Mons, Gaithersberg, MD (US)

Correspondence Address: Rahman LLC, 10025 Governor Warfield Parkway, Suite 110, Columbia, MD, 21044, US

(21) Appl. No.: 12/594,131

(22) PCT Filed: Mar. 31, 2008
(86) PCT No.: PCT/US08/04151

§ 371 Date: Mar. 17, 2010

Related U.S. Application Data
(60) Provisional application No. 60/909,072, filed on Mar. 30, 2007.
(60) Provisional application No. 61/064,211, filed on Feb. 21, 2008.
(60) Provisional application No. 61/064,345, filed on Feb. 29, 2008.
(60) Provisional application No. 61/064,670, filed on Mar. 19, 2008.
(60) Provisional application No. 61/064,780, filed on Mar. 26, 2008.

(51) Int. Cl. G06F 3/01; G06F 17/30; G06F 17/00

(52) U.S. Cl. 707/769; 715/760; 707/802; 715/205; 715/234; 707/E17.014; 707/E17.044

(57) ABSTRACT

Systems, methods and computer program products for navigating concepts found in data produced by intellectuals in a knowledge discovery process are disclosed. The present invention utilizes data sources and facilities for enabling community-based contributions for identifying associations between concepts disclosed by intellectuals. The present invention's approach results in having concepts mapped to authors and tools for linking related concepts with groups of intellectuals and/or contributors.

### CROSS-REFERENCE TO RELATED APPLICATIONS

This Application claims the benefit of, and is related to, the following of Applicants' co-pending applications:

U.S. Provisional Patent Application No. 61/064,345 titled “Enhanced System and Method for Knowledge Navigation and Discovery” filed on Feb. 28, 2008;

U.S. Provisional Patent Application No. 61/064,211 titled “System and Method for Knowledge Navigation and Discovery” filed on Feb. 21, 2008;

U.S. Provisional Patent Application No. ______ titled “Enhanced System and Method for Knowledge Navigation and Discovery” filed on Mar. 19, 2008;

U.S. Provisional Patent Application No. ______ titled “System and Method for Knowledge Navigation and Discovery Via Intellectual Networking” filed 26 Mar. 2008;

U.S. Provisional Patent Application No. 60/909,072 titled “Method and Object for Knowledge Discovery” filed on Mar. 30, 2007; and

U.S. Non-Provisional Patent Application No. ______ titled “Data Structure, System and Method for Knowledge Navigation and Discovery” filed Mar. 31, 2008; each of which is incorporated by reference herein in its entirety.

### BACKGROUND OF THE INVENTION

1. Field of the Invention

The present invention generally relates to systems and methods for intellectual networking, and more particularly to systems and methods for navigating among the concepts found in the large amounts of data produced by intellectuals in order to facilitate the knowledge discovery process.

2. Related Art

In the current information era, information is being created at a phenomenal pace. For example, it has been estimated that the global, public Internet has over 500 billion pages of information spread out over 100 million Web sites and is growing every day. Such growth comes not only from Web site operators who “officially” post news stories, scientific research, Web logs (or “blogs”) and the like, but also from members of the public at large. That is, the Internet's vast amount of pages of data also grows as a result of various “Wiki”—type sites, which are typically collaborative Web sites that users can easily modify, usually without much restriction. (A wiki allows anyone, using a Web browser, to edit, delete or modify content that has been placed on the site, including the work of other authors.)

As information is being created at a phenomenal pace, with the Internet serving as just one convenient example of a data repository, locating and analyzing the relevant pieces of certain information has never been a more important yet labor-intensive task, relevant to all aspects of human society. Due to the fact that large amounts of information have been encoded in natural language text, finding the “golden nuggets” of relevant information in large collections of text is often dubbed “text mining.” Two main methodological approaches to text mining have developed over time—Information Retrieval (IR) and Information Extraction (IE).

### Information Retrieval: Finding Documents

The problem of information retrieval is as old as the origin of libraries and archives. Once books or other media containing information have been stored, they have to be found. Catalogs and indexes are common tools for accessing large collections. In the computer age, where many texts have been digitized, computational tools have been developed to index and retrieve documents from large collections. Users of these tools typically use “keywords” or sentences to query the database, and the classical result is a list of publications deemed relevant to the query. For example, the query “Find papers that discuss new treatments for lung cancer” will likely return references to papers describing recent clinical trials testing drugs for lung cancer.

Research and development in using computers for IR dates back to the 1950's. Various algorithms and applications have been developed, and scientific researchers use IR tools on a daily basis, due to the fact that many bibliographic and other information sources are available online. For example, searching the Web using Google or Yahoo! is a typical IR task. From a methodological point of view, three different approaches to IR can be distinguished: Boolean, probabilistic, and vector space search.

One of the most widely-used biomedical bibliographic databases is PubMed, which uses a Boolean model. The query above, for example, would be transformed to something like “lung cancer AND treatment.” While PubMed offers much refinement using keyword searching, it is still vulnerable to the typical disadvantages of Boolean searching: highly specific queries such as “papers AND discuss AND new treatments AND lung cancer” will typically yield results ranging from few to none. Furthermore, the results adhere to the word based and Boolean queries, and rank ordering the results based on relevance is typically not possible.

Both probabilistic and vector space searching offer a more sophisticated tool to deal with refined queries. For vector space retrieval, both the documents in a collection and the queries are represented by a vector of the most important words (i.e., keywords) in the text. For instance, the vector {papers, discuss, new treatments, lung cancer} represents the query above. Numeric values representing importance are assigned. After the documents and query have been transformed into a vector, angles between query and document vectors are typically computed. The smaller the angle between two vectors, the more similar these vectors are, or, in other words, the more similar or associated a document is to the query. The result of a vector space query is a list of documents that are similar in vector space. The first major improvement over Boolean systems is that the results can be rank-ordered. Thus, the first result is typically more relevant to the query than the last. The second major improvement is that even if not all words from the query are in any one document, in most cases the system will still return relevant results. Generally, the more refined and extensive a query is, the more refined the results are.

### Information Extraction: Finding Facts

While an IR query results in a list of publications that are potentially relevant to a user's query, the user still has to read through the resulting papers to extract the relevant information. Returning to the sample query above, for example, a user may not be interested in simply seeing a list of papers describing new treatments for lung cancer, but might prefer an actual list of these new treatments. Thus, considerable effort has been put into the discipline of IE.

One of the central approaches to IE has been to predefine a template of a certain fact or fact combination. For example, a biochemical reaction involves not only different reactants, but often also a mediator molecule (i.e., a catalyst). Further, such reactions are often localized to specific cells, and even to specific parts of a cell. Extraction algorithms would first search for the part in the text that mentions one or more of the reactants then attempt to fill in the template by, for example, interpreting the name of a cell type as the location of the reaction. In many cases, advanced Natural Language Processing (NLP) techniques are needed as it is important not to interchange the subject and the object. Also, semantic analysis to extract the actual meaning is needed. The sentence “Lung cancer patients taking cisplatinum showed some improvement” does imply that the drug cisplatinum is used for treating lung cancer. The knowledge that cisplatinum is a drug, and that lung cancer is a disease, would greatly facilitate the computation of the relation “cisplatinum treats lung cancer.” The computational efforts for this interpretation are much more demanding than for general IR, which explains why research and development in IE has only recently resulted in specialized systems that produce sufficiently accurate results.

### Beyond Mining: Discovery

While the explosion of digitally recorded information has daunting consequences for storage and retrieval, it also opens interesting avenues for knowledge discovery. Throughout human history, researchers have combined existing information with hunches to formulate hypotheses that are subsequently subject to testing. Human capacity to absorb information is limited, however, and computational tools to support hypothesis generation by processing large amounts of information comprise a promising tool in conducting research. Two main methodological approaches have been developed in this area, namely, relational discovery and associative discovery.

### Relational Discovery

Pioneering research by Professor Don Swanson resulted in novel scientific hypotheses that have been corroborated by experiments. See Swanson, D. R. “Undiscovered Public Knowledge,” Library Quarterly, 1986; 56:103-118, the entirety of which is incorporated by reference herein. Swanson's assumption is that if a scientific paper mentions a relationship between A and B, and another paper indicates a relationship between B and C, then hypothetically, A and C are related without the necessity of a factual record of this relationship. As current science is highly specialized and compartmentalized, the paper that states the A-B relationship could be unknown and irretrievable by a researcher specialized in C. Swanson's first discovery, for example, was that Eskimos have a fish-rich diet, and the intake of fatty acids in fish oils (A) is known to lower blood platelet aggregation and blood viscosity (B). Eskimos have therefore a lower incidence of different heart-related diseases. In an unrelated medical discipline studying Raynaud's disease (C), it was found that patients with this disease suffer from increased blood viscosity and above normal blood platelet aggregation (B). See Swanson D. R., “Fish Oil, Raynaud's Syndrome, and Undiscovered Public Knowledge,” Perspectives in Biology and Medicine, 1986; 30:7-18, the entirety of which is incorporated by reference herein. The transitive relationship that fish oil might improve the health of Raynaud's disease patients easily emerges, and was proven a few years after Swanson formulated the hypothesis by combining the information published in two unrelated scientific disciplines. In the past few years, different literature-based discovery tools have been developed that utilize the relational discovery principle. All of them to date, however, are in experimental stages, and not user-friendly.

### Associative Discovery

Another approach to hypothesizing novel relationships from existing data is to employ standard IR tools. The key issue here is that a transformation is needed from a document world to an “object” world. An object can be anything that represents a concept or real-world entity. For example, documents describing a certain disease may be combined or clustered into a format that is typical for that disease. The vector space model, for example, can easily accommodate this transformation. The vectors of the documents describing the disease can be combined into one vector representing the disease. In this way, collections of documents may be transformed into collections of diseases, drug, genes, proteins, etc. Using this approach, discovery comprises finding objects associated with the query object in the vector space. For example, if the query object is “lung cancer,” and the query is conducted on a collection of drug objects, the rank-ordered result of the query will contain not only drugs that have been mentioned together with lung cancer, but also drugs that have never been studied in this disease's context, which may be hypothetical new treatments for lung cancer. Similarly, a query using a vector representing Raynaud's disease in an object database storing chemicals and drugs will result in both existing treatments and potentially new treatments (such as fish oil). An important aspect of this “object” approach is that a search with any kind of object may be conducted, and any other kind of object may be requested.

### Researchers' Needs

The most common motivation of research scientists—just one class of users of vast data stores such as the Internet—is to understand why things work the way they work. Researches develop various experiments to replicate certain conditions and find out why things happen. Executing the experiment is very often another main motivation of a researcher.

The life cycle of a scientific project starts with the birth of an idea, which may be a well-defined hypothesis or just a hunch, by one or more scientists. The idea often follows from previous experimental outcomes that are combined with reported knowledge and novel hypotheses. The challenge of today's data and knowledge deluge is to optimally combine the widely varying sources of information and knowledge to select only the most promising hypotheses.

Further, researchers continuously scan the scientific radar for emerging information. Current electronic tools that automatically increase the pile of papers to be read should be replaced by tools that digest most of the information and only emit warning signals when truly interesting knowledge has just been or is about to be discovered.

Given the foregoing problems of large data stores and the limitations of conventional text mining, what are needed are data structures, systems, methods and computer program products for knowledge navigation and discovery. Such data structures, systems, methods and computer program products should allow vast data stores to be semantically searched, navigated, compressed and stored in order to facilitate relational, associative and/or other types of knowledge discovery.

### BRIEF DESCRIPTION OF THE INVENTION

Aspects of the present invention meet the above-identified needs by providing enhanced systems, methods and computer program products for knowledge navigation and discovery, particularly within the context of intellectual networking sites.

Based on concepts or units of thought rather than words, the data structures, systems, methods and computer program products for facilitating knowledge navigation and discovery are independent of choice of language and other concept representations. For a given field of study or endeavor, every concept in a thesaurus or ontology, or a collection thereof, is assigned a unique identifier. Two basic types of concepts are defined: (a) a source concept, corresponding to a query; and (b) a target concept, corresponding to a concept having some relationship with the source concept. Each concept, identified by its unique identifier, is assigned minimally three attributes: (1) factual; (2) co-occurrence; and (3) associative values. The source concept with all its associated (target) concepts that relate to the source concept with one or more of the attributes is stored in a novel data structure referred to as a “Knowlet™”. (As will be appreciated by those skilled in the relevant art(s), a data structure is a way of storing data in a computer so that it can be used efficiently. Often a carefully chosen data structure will allow the most efficient algorithm to be used. A well-designed data structure allows a variety of critical operations to be performed, using as few resources, both in terms of execution time and memory space, as possible. Data structures are implemented using data types, references and operations on them provided by a programming language.)

The factual attribute, F, is an indication of whether the concept has been mentioned in authoritative databases (i.e., databases or other repositories of data that have been deemed authoritative by the scientific community in a given area of science and/or other area of human endeavor). The factual attribute is not, in and of itself, an indication of the veracity or falsehood of the source and target concepts relationship.

The co-occurrence attribute, C, is an indication of whether the source concept has been mentioned together with the target concept in a unit of text (e.g., in the same sentence, in the same paragraph, in the same abstract, etc.) within a database or other data store or repository that have not been deemed authoritative. Again, the co-occurrence attribute is not, in and of itself, an indication of the veracity or falsehood of the concepts relationship.

The associative attribute, A, is an indication of conceptual overlap between the two concepts.

The Knowlet, with its three F, C, and A attributes represents a “concept cloud.” When an interrelation is created among the concept clouds of all identified concepts, a “concept space” is created. It should be noted that the Knowlets and their respective F, C, and A attributes are periodically updated (and may be changed), as databases and other repositories of data are populated with new information. The collection of Knowlets and their respective F, C, and A attributes are then stored in a knowledge database.

In one aspect of the present invention, the data structure, system, method and computer program product for knowledge navigation and discovery utilize an indexer to index a given source (e.g., textual) of knowledge using a thesaurus (also referred to as “highlighting on the fly”). A matching engine is then used to create the F, C, and A attributes for each Knowlet. A database stores the Knowlet space. The semantic associations between every pair of Knowlets/concepts are calculated based on the F, C, and A attributes for a given concept space. The Knowlet matrix and the semantic distances may be used for meta analysis of entire fields of knowledge, by showing possible associations between concepts that were previously unexplored.

An advantage of aspects of the present invention is that it can be provided as a research tool in the form of a Web-based or proprietary search engine, Internet browser plug-in, Wiki, or proxy server.

Another advantage of aspects of the present invention is that it allows users not only to make new (relational and associative) discoveries using concepts, but also allows such users to find experts related to a concept using authorship information located in the data store.

Another advantage of aspects of the present invention is that it uses a novel data structure called a “Knowlet” which allows scientists to make new (relational and associative) discoveries using concepts (and their automatically included synonyms) from a data store and a relevant (e.g., biomedical) ontology or thesaurus.

Another advantage of aspects of the present invention is that Knowlets enable precise information retrieval and extraction as well as relational and associative discovery and can be applied to any collection of content in any discipline at any level of scientific detail and explanation.

Yet another advantage of aspects of the present invention is that redundancy from the World Wide Web, or any other data store, may be removed without losing unique information bits, thereby resulting in a compressed or “zipped” version of the Web that may be more easily stored, searched and shared.

Yet another advantage of aspects of the present invention is that it allows more complex (and thorough) Internet search queries to be automatically built during concept browsing than can ever be crafted by humans.

Yet another advantage of aspects of the present invention is that it allows public data stores and authoritative ontologies or thesauri, to be augmented by private data stores and ontologies or thesauri thereby allowing for a more complete concept space and thus more knowledge navigation and discovery capabilities.

Yet another advantage of aspects of the present invention is that it allows users to more easily identify experts related to particular concepts for collaborative research purposes.

Further features and advantages of aspects of the present invention, as well as the structure and operation of these various aspects of the present invention, are described in detail below with reference to the accompanying drawings and computer listing appendix.

### BRIEF DESCRIPTION OF THE FIGURES AND APPENDICES

The features and advantages of the present invention will become more apparent from the detailed description set forth below when taken in conjunction with the drawings in which like reference numbers indicate identical or functionally similar elements. Additionally, the left-most digit of a reference number identifies the drawing in which the reference number first appears.

FIG. 1 is a system diagram of an exemplary environment, in which the present invention, in one aspect, may be implemented.

FIG. 2 is a block diagram of an exemplary computer system useful for implementing the present invention.

FIG. 3 is a flowchart depicting an exemplary Knowlet space creation and navigation process according to an aspect of the present invention.

FIG. 4 is a block diagram depicting an exemplary composition of a Knowlet data structure according to an aspect of the present invention.

FIGS. 5A & 5B are flowcharts depicting an exemplary login process according to an aspect of the present invention.

FIG. 6 is a flowchart depicting an exemplary Wikifier functionality according to an aspect of the present invention.

FIG. 7 is a flowchart depicting an exemplary click and link functionality according to an aspect of the present invention.

FIGS. 8A & 8B are flowcharts depicting an exemplary Wikifier functionality according to an aspect of the present invention.

FIGS. 9-28 are exemplary windows or Graphic User Interface (GUI) screens generated by aspects of the graphical user interface of the present invention.

### DETAILED DESCRIPTION

### Overview

Aspects of the present invention are directed to systems, methods and computer program products for knowledge navigation and discovery within the context of intellectual networking sites.

In one aspect of the present invention, an automated tool is provided to users, such as biomedical research scientists, to allow them to navigate, search and perform knowledge discovery within a vast data store, such as PubMed—one of the most-widely used biomedical bibliographic databases which is maintained and provided by the U.S. National Library of Medicine. PubMed includes over 17 million abstracts and citations of biomedical articles dating back to the 1950's. In such an aspect, the present invention does more than simply allow biomedical researchers to perform Boolean searches using keywords to find relevant articles. Using a novel data structure, interchangeably referred to herein as a “Knowlet,” one aspect of the present invention allows scientists to make new relational, associative and/or other discoveries using concepts or units of thought (which would automatically include all synonyms of a concept expressed in a given language) from a data store and a relevant (e.g., biomedical) ontology or thesaurus, such as the United States National Library of Medicine's Unified Medical Language System® (UMLS) databases that contain information about biomedical and health related concepts.

Aspects of the present invention are now described in more detail herein in terms of the above exemplary biomedical researcher using the PubMed data store and a biomedical ontology. This description is provided for convenience only, and is not intended to limit the application of the present invention. After reading the description herein, it will be apparent to one skilled in the relevant art(s) how to implement the present invention in alternative aspects. For example, the present invention may be applied in any of the following areas, among others, where there is a vast data store, a relevant ontology/thesaurus, and a need for knowledge navigation and (relational, associative, and/or other) knowledge discovery:
The intelligence community may benefit from the present invention, in one aspect, by mining vast amounts of intercepted e-mails and/or other information, in different languages, suggesting suspicious Knowlets and associations, and mining for seemingly unrelated facts in large bodies of documents, for example.
The financial community may benefit from the present invention, in one aspect, by creating profiles of any document related to a financing deal structure, for example, including Knowlets of performance trends, management, and SEC filings, among others.
The legal community may benefit from the present invention, in one aspect, by profiling all cases and related rulings, and by creating the opportunity to not only find related documents, experts and rulings, but also to mine for potential relationships between concepts in large amounts of documents pertaining to one particular case (e.g., document production), for example.
The business community may benefit from the present invention, in one aspect, by mining a data store of owned patents and patent applications to find potential companies interested in licensing technologies similar to those disclosed therein, and by creating knowledge maps of companies involved in merger or acquisition activities, for example.
The health care community may benefit from the present invention, in one aspect, by relating patient databases with the scientific literature would allow patients to create online “patient Knowlets” and be alerted to new information relevant to a particular disease or new medications that become available for that disease; these patient Knowlets may also serve as a basis for studies performed on patients with rare diseases, for example.

The terms “user,” “end user”, “researcher”, “customer”, “expert”, “author”, “scientist”, “member of the public” and/or the plural form of these terms may be used interchangeably throughout herein to refer to those persons or entities capable of accessing, using, be affected by and/or benefiting from the tool that the present invention provides for knowledge navigation and discovery.

### The System

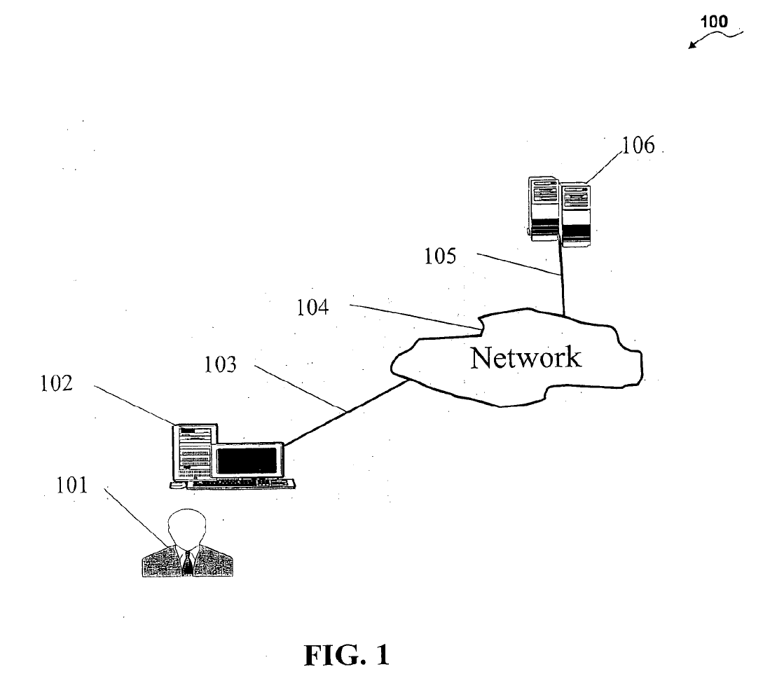

FIG. 1 presents an exemplary system diagram 100 of various hardware components and other features in accordance with an aspect of the present invention. As shown in FIG. 1, in an aspect of the present invention, data and other information and services for use in the system is, for example, input by a user 101 via a terminal 102, such as a personal computer (PC), minicomputer, laptop, palmtop, mainframe computer, microcomputer, telephone device, mobile device, personal digital assistant (PDA), or other device having a processor and input and display capability. The terminal 102 is coupled to a server 106, such as a PC, minicomputer, mainframe computer, microcomputer, or other device having a processor and a repository for data or connection to a repository for maintaining data, via a network 104, such as the Internet, via communication couplings 103 and 105.

As will be appreciated by those skilled in the relevant art(s) after reading the description herein, in such an aspect, a service provider may allow access, on a free registration, paid subscriber and/or pay-per-use basis, to the knowledge navigation and discovery tool via a World-Wide Web (WWW) site on the Internet 104. Thus, system 100 is scaleable such that multiple users, entities or organizations may subscribe and utilize it to allow their users 101 (i.e., their scientists, researchers, authors and/or the public at large who wish to perform research) to search, submit queries, review results, and generally manipulate the databases and tools associated with system 100.

As will also be appreciated by those skilled in the relevant art(s) after reading the description herein, alternate aspects of the present invention may include providing the tool for knowledge navigation and discovery as a stand-alone system (e.g., installed on one PC) or as an enterprise system wherein all the components of system 100 are connected and communicate via a secure, inter-corporate, wide area network (WAN) or local area network (LAN), rather than as a Web service as shown in FIG. 1.

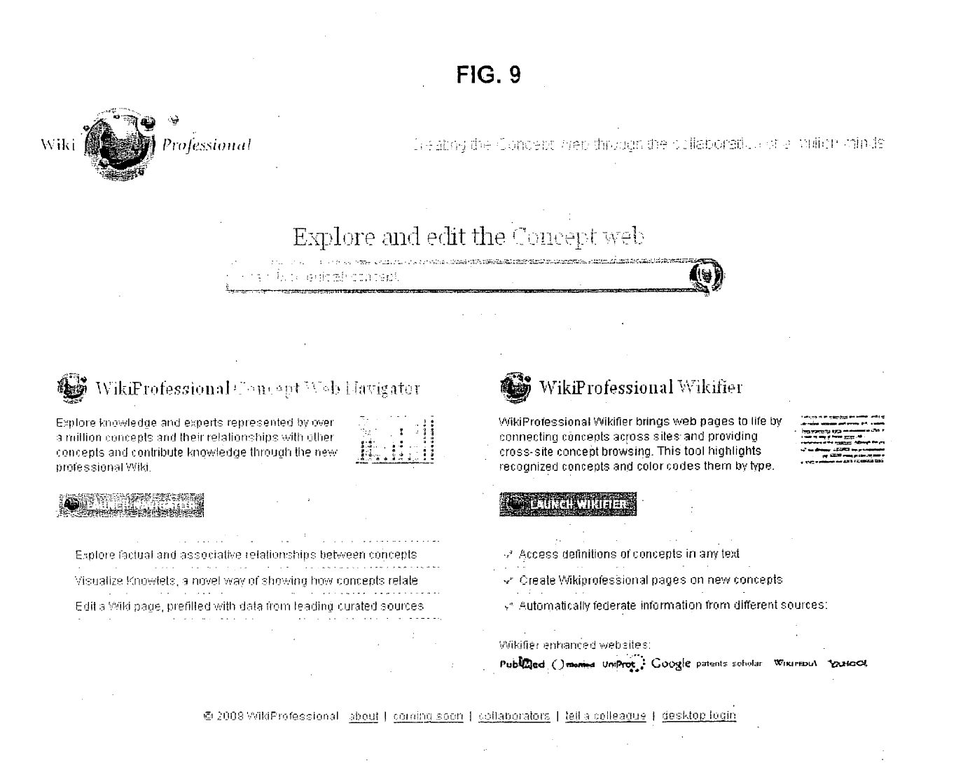

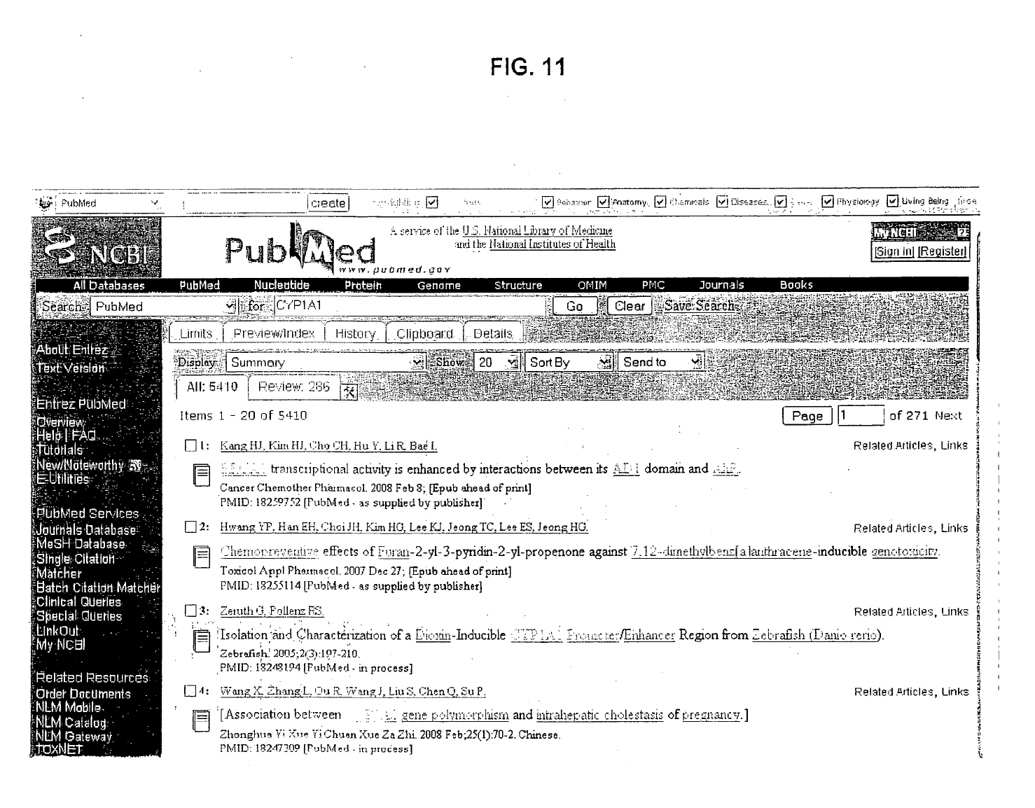

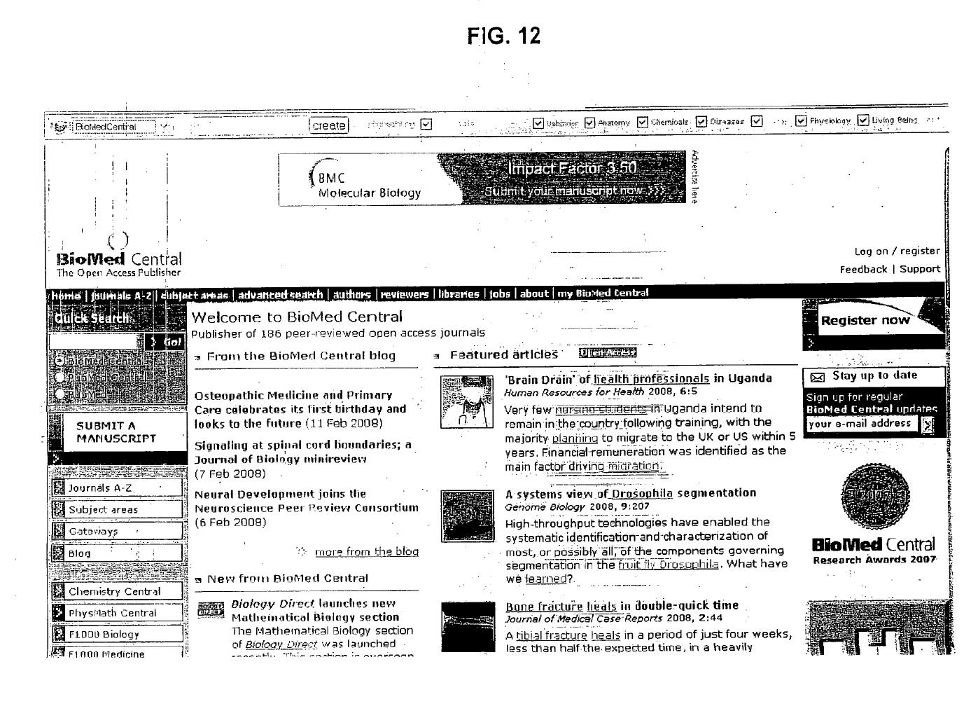

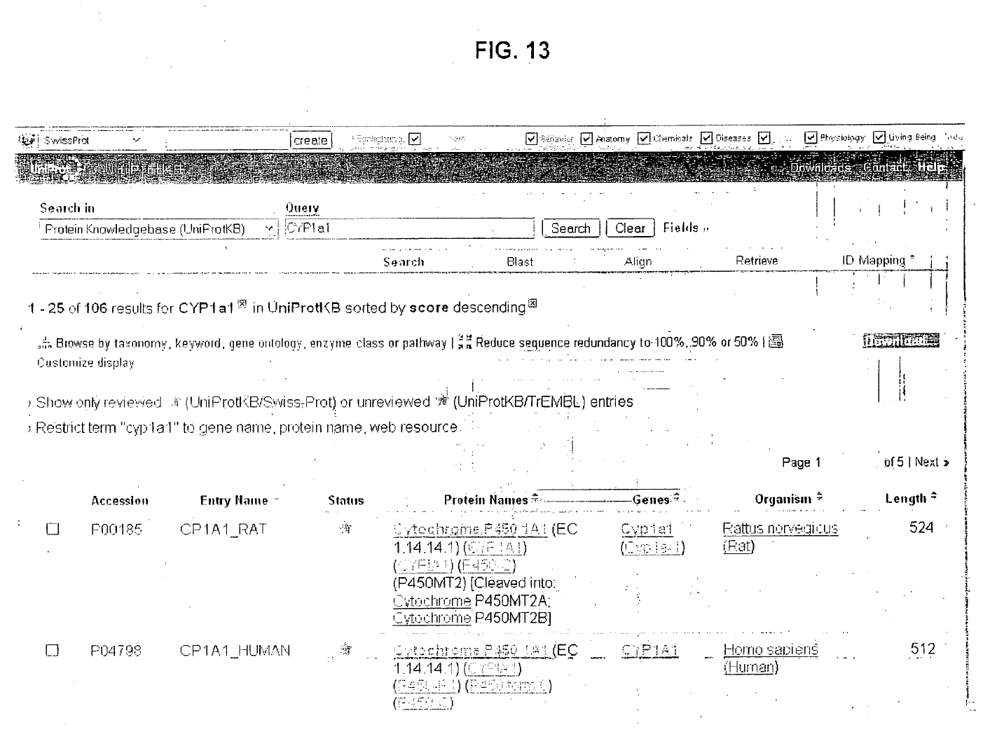

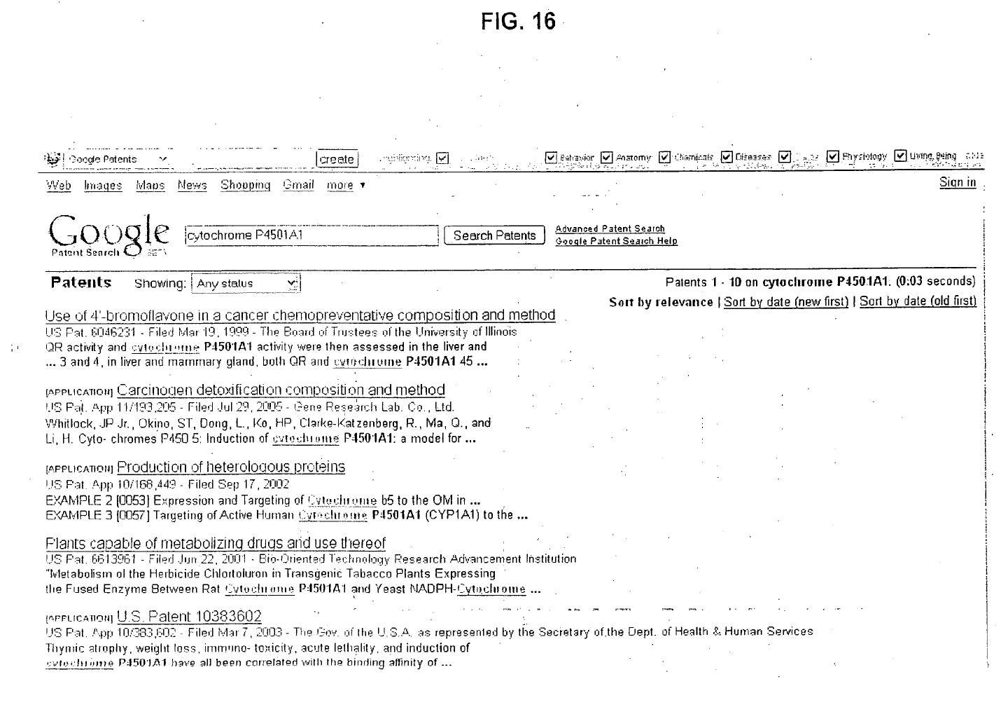

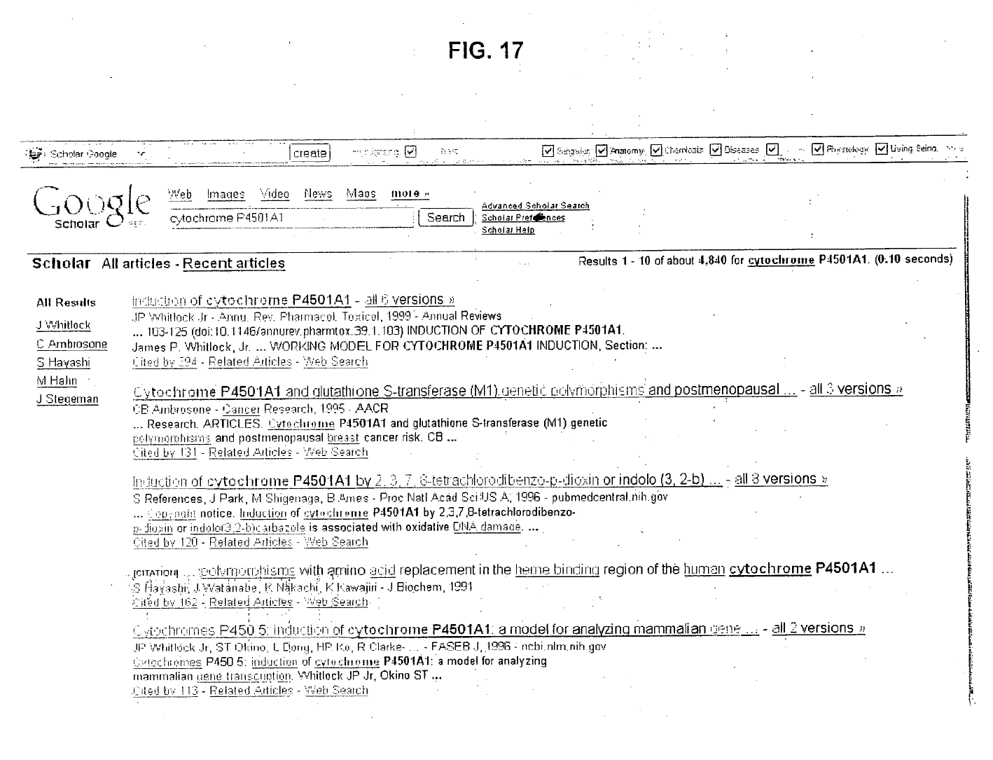

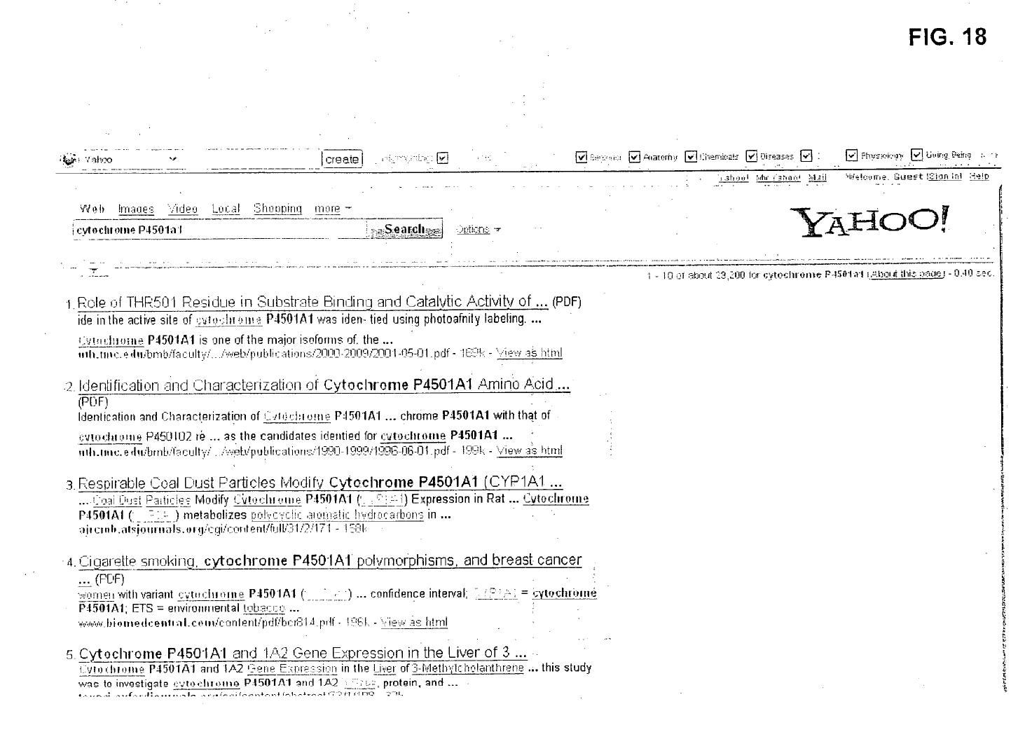

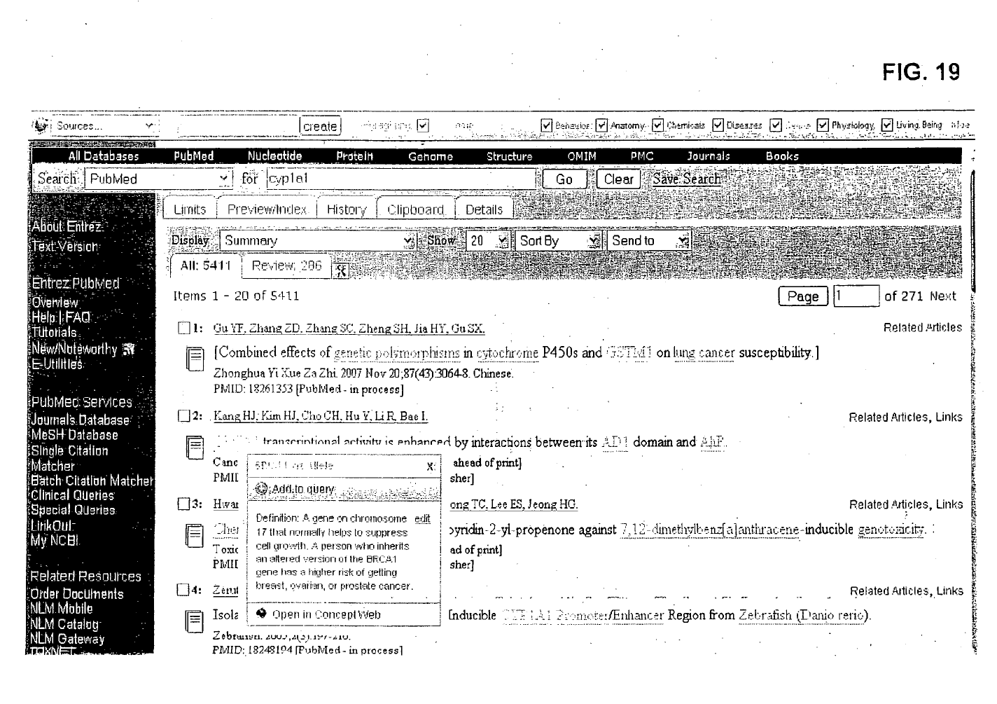

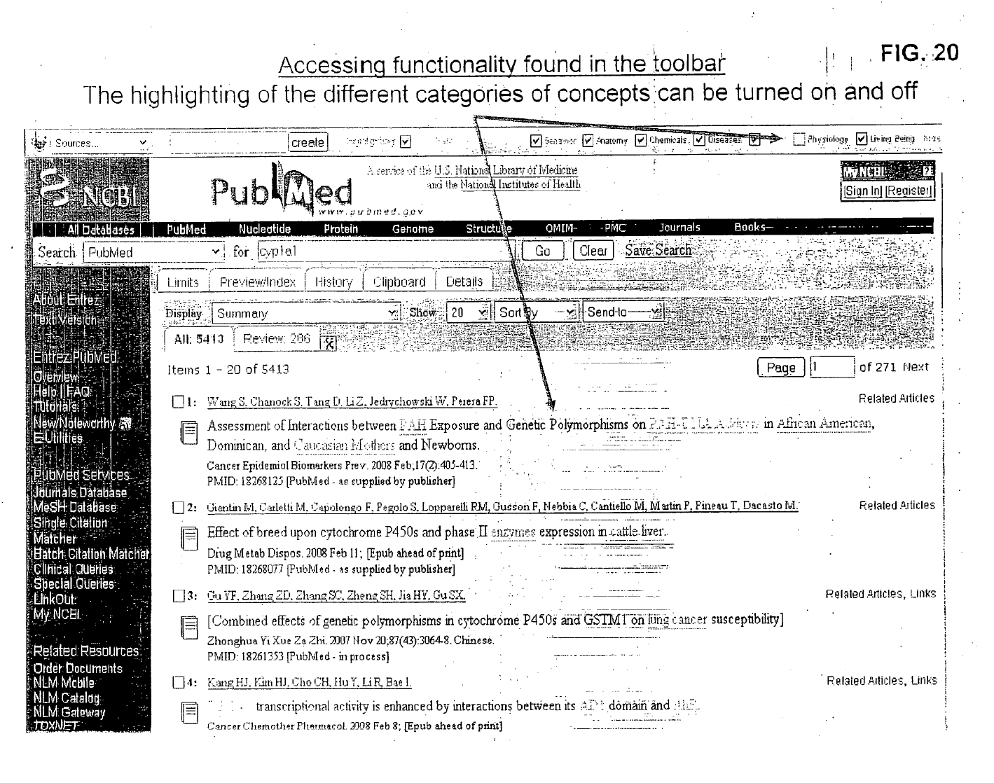

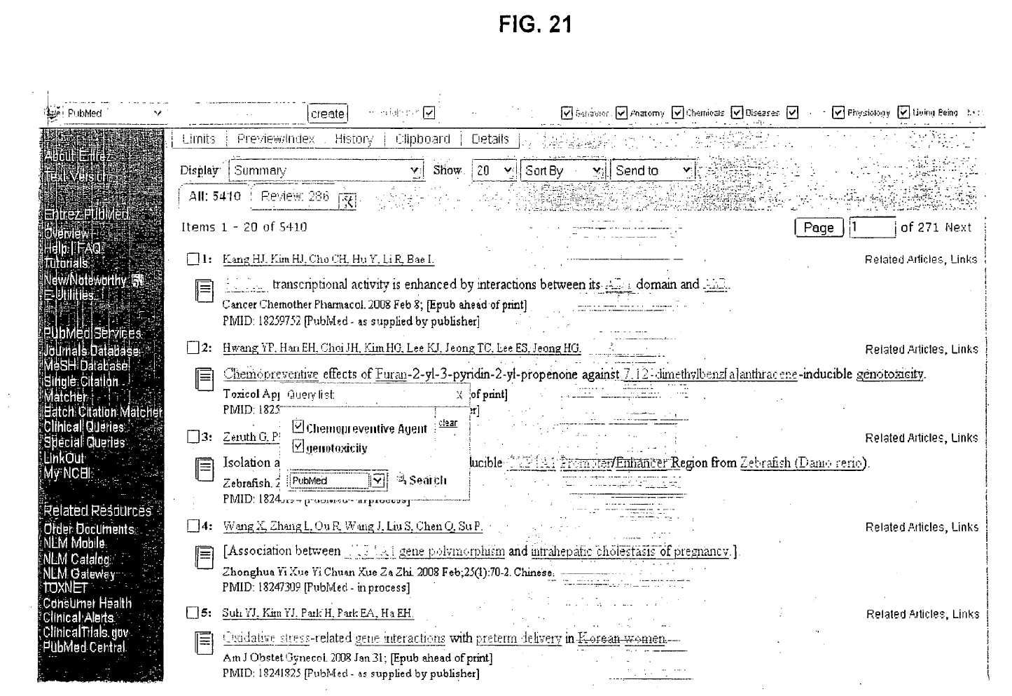

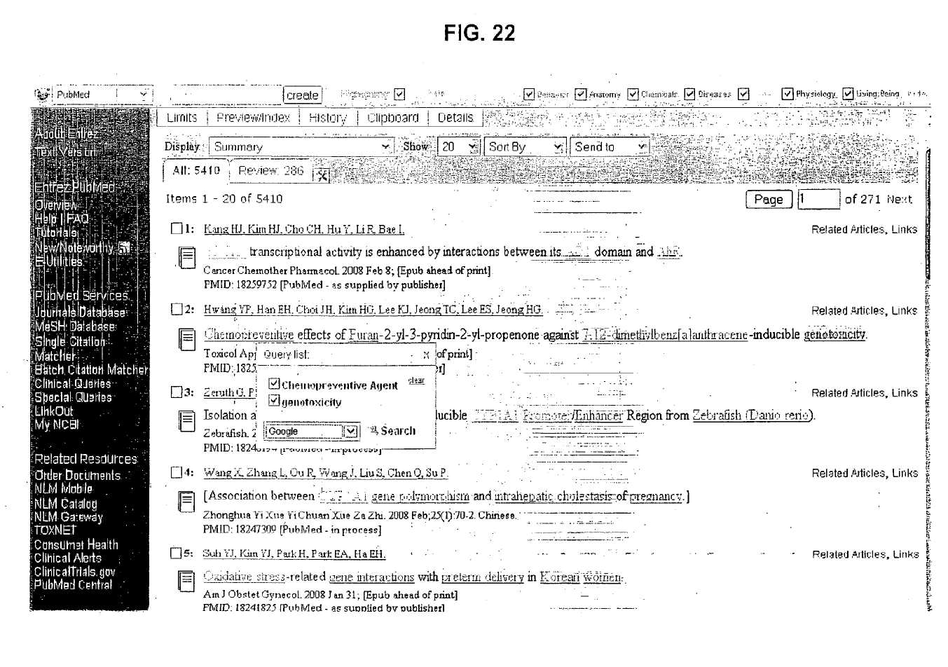

As will be appreciated by those skilled in the relevant art(s), in an aspect, graphical user interface (GUI) screens may be generated by server 106 in response to input from user 101 over the Internet 104. That is, in such an aspect, server 106 is a typical Web server running a server application at a Web site which sends out Web pages in response to Hypertext Transfer Protocol (HTTP) or Hypertext Transfer Protocol Secured (HTTPS) requests from remote browsers being used by users 101. Thus, server 106 (while performing any of the steps of process 300 described below) is able to provide a GUI to users 101 of system 100 in the form of Web pages. These Web pages sent to the user's PC, laptop, mobile device, PDA or the like device 102, and would result in GUI screens (e.g., screens in FIGS. 9-28) being displayed.

### The Knowlet

In aspects of the present invention, a novel data element or structure called a “Knowlet” is employed to enable lightweight storage, precise information retrieval and extraction as well as relational, associative and/or other discovery. That is, each concept in a relevant ontology or thesaurus (in any discipline at any level of scientific detail) may be represented by a Knowlet such that it is a semantic representation of the concept, resulting from a combination of factual information extraction, co-occurrence based connections and associations (e.g., vector-based) in a concept space. The factual (F), the textual co-occurrence (C), as well as the associative (A) attributes or values between the concept in question and all other concepts in the relevant ontology or thesaurus, and with respect to one or more relevant data stores, are stored in the Knowlet for each individual concept.

In an aspect, the Knowlet can take the form of a Zope (an open-source, object-oriented web application server written in the Python programming language distributed under the terms of the Zope Public License by the Zope Corp. of Fredericksburg, Va.) data element that stores all forms of relationships between a source concept and all its target concepts, including the values of the semantic associations to such target concepts).

Using such Knowlets, as will be described in more detail below, a “semantic distance” (or “semantic relationship”) value may be calculated for presentment to a user. The semantic distance is the distance or proximity between two concepts in a defined concept space, which can differ based on which data store or repository of data (i.e., collection of documents) used to create the concept space, but also based on the matching control logic used to define the matching between the two concepts, and the relative weight given to factual (F), co-occurrence (C) and associative (A) attributes. The goal of such an approach is to replicate key elements of the human brain's associative reasoning functionality. Just as humans use an association matrix of concepts “they know about” to read and understand a text, aspects of the present invention seek to apply this power of vast and diverse elements of human thought to data stores or repositories of data. Given the above, aspects of the present invention are able to “overlay” concepts within a given text with factual, co-occurrence and associative attributes, for example. It will be recognized by those of ordinary skill in the art, however, that any number of attributes may be used, as long as these attribute(s) represent a relationship that may link a given concept with another concept.

Computer program listing Appendix 1 presents an XML representation of an exemplary Knowlet according to an aspect of the present invention. In such an aspect of the present invention, Knowlets can be exported into standard ontology and Web languages such as the Resource Description Framework (RDF) and the Web Ontology Language (OWL). Therefore, any application using such languages may be enabled to use the Knowlet output of the present invention for reasoning and querying with programs such as the SPARQL Protocol and RDF Query Language.

### The Methodology

In one aspect of the present invention, a search tool is provided to user 101 for knowledge navigation and discovery. In such an exemplary aspect, an automated tool is provided to users, such as biomedical research scientists, to allow them to navigate, search and perform knowledge discovery within a vast data store, such as PubMed.

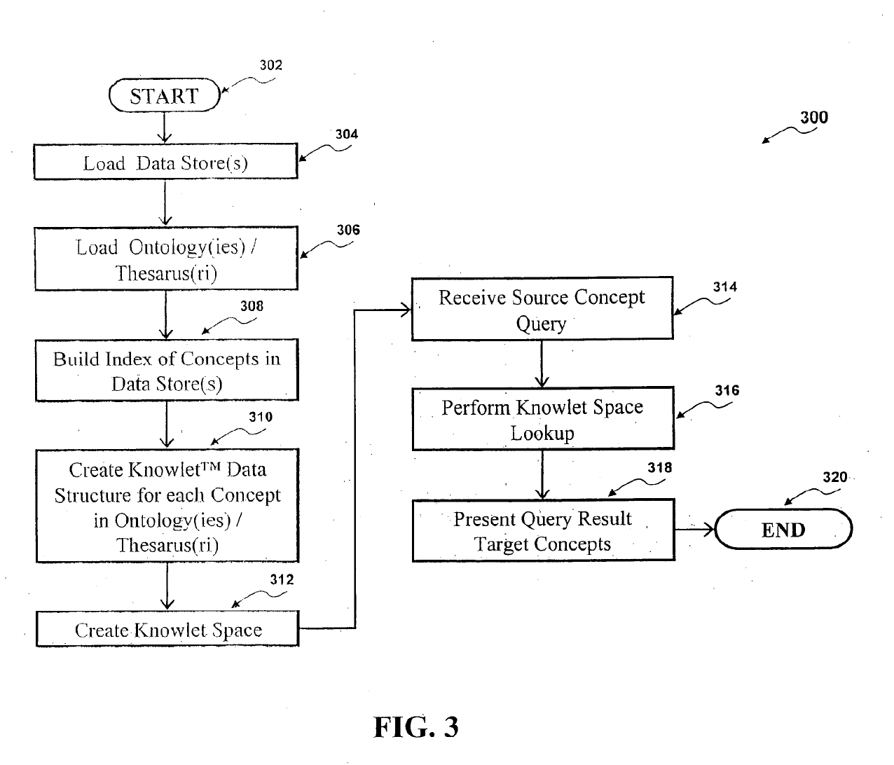

Referring to FIG. 3, a flowchart depicting an exemplary Knowlet space creation and navigation process 300 of the automated tool according to an aspect of the present invention is shown. Process 300 begins at step 302 with control passing immediately to step 304.

In such an aspect of the present invention, step 304 connects system 100 to one or more data stores (e.g., PubMed) containing the knowledge base in which the user seeks to navigate, search and discover.

In such an aspect of the present invention, step 306 connects the system to one or more ontologies or thesauri relevant to the data store(s). Thus, where the data store is one of biomedical abstracts, for example, the ontology may be one or more of the following ontologies, among others: the UMLS (as of 2006, the UMLS contained well over 1,300,000 concepts); the UniProtKB/Swiss-Prot Protein Knowledgebase, an annotated protein sequence database established in 1986; the IntAct, a freely available, open source database system for protein interaction data derived from literature curation or direct user submissions; the Gene Ontology (GO) Database, an ontology of gene products described in terms of their associated biological processes, cellular components and molecular functions in a species-independent manner; and the like.

As will be appreciated by those skilled in the relevant art(s) after reading the description herein, aspects of the present invention are language-independent, and each concept may be given a unique numerical identifier and synonyms (whether in the same natural language, jargon or in different languages) of that concept would be given the same numerical identifier. This helps the user navigate, search and perform discovery activities in a non-language specific (or dependent) manner.

In such an aspect of the present invention, step 308 goes through each record of the data store (e.g., go through each abstract of the PubMed database), tags the concepts from the ontology (e.g., ULMS) that appear in each record, and builds an index recording the locations where each concept is found in each record (e.g., each abstract in PubMed). In one aspect, the index built in step 308 is accomplished by utilizing an indexer (sometimes referred to as a “tagger”) which are known in the relevant art(s). In such an aspect, the indexer is a named entity recognition (NER) indexer (which utilizes the one or more ontologies or thesauri relevant to the data store(s) loaded in step 306) such as the Peregrine indexer developed by the Biosemantics Group, Medical Informatics Department, Erasmus University Medical Center, Rotterdam, The Netherlands; and described in Schuemie M., Jelier R., Kors J., “Peregrine: Lightweight Gene Name Normalization by Dictionary Lookup” Proceedings of Biocreative 2, which is hereby incorporated by reference in its entirety. Examples of other NER indexers include: the ClearForest Tagging Engine available from Rueters/ClearForest of Waltham, Mass.; the GENIA Tagger available from the Department of Information Science, Faculty of Science, University of Tokyo; the iHOP service available from http://www.ihop-net.org; IPA available from Ingenutity Systems of Redwood City, Calif.; Insight Discoverer™ Extractor available from Temis S.A. of Paris, France; and the like.

In one aspect of the present invention, step 310 creates a Knowlet for each concept in the ontology which “records” the relationship between that concept and all other concepts (as well as semantic distances/associations) within the concept space. In such an aspect, a search engine, such as the Lucene Search Engine, may be used to search the data store(s) for the occurrences of the concepts loaded into the system in step 306 and to determine the relationships between the concepts using the index created in step 308. The Lucene Search Engine, used in this example, is available under the Apache Software Foundation License and is a high-performance, full-featured text search engine library written in Java suitable for nearly any application that requires full-text (especially cross-platform) search.

In such an aspect of the present invention, step 312 creates and stores within the system (e.g., storing within a data store associated with server 106) a “Knowlet space” (or concept space), which is a collection of all the Knowlets created in step 310, thus forming a larger, dynamic ontology. Thus, if the ontology contains N concepts, the Knowlet space may be (at most) a [N]×[N−1]×[3] matrix detailing how each of N concepts relates to all other N−1 concepts in a Factual (F), Co-occurrence and (C) Associative (A) manner. In such an aspect of the present invention, step 312 includes the steps of calculating the F, C and A attributes (or values) for each concept pair. Thus, the Knowlet space is a virtual concept space based on all Knowlets, where each concept is the source concept for its own Knowlet and a target concept for all other Knowlets. (When the F, C or A values are non-zero within a Knowlet for a particular source/target concept combination, this is denoted herein as being in a F+, C+ or A+ state, respectively. And, when the values are less than or equal to zero, they are denoted as F−, C− or A−, respectively.)

As will be appreciated by those skilled in the relevant arts after reading the description herein, in the aspect of the present invention where the ontology is the UMLS, N may be well over 1,000,000 in magnitude.

As noted above, however, one aspect of the present invention contemplates the use of any number of attributes. Thus, in such an aspect, the Knowlet space may be represented as an [N]×[N−1]×[Z] matrix detailing how each of N concepts relates to all other N−1 concepts with respect to each of Z attributes. In such an aspect of the present invention, step 312 would include the steps of calculating Z number of attributes (or values) for each concept pair.

As will be appreciated by those skilled in the relevant arts after reading the description herein, in the aspect of the present invention, the Knowlet space may be made smaller (and thus optimized for computer memory storage and processing) than a [N]×[N−1]×[Z] matrix by reducing the [N−1] portion of the Knowlet. This is accomplished by a scheme where each concept is the source concept for its own Knowlet, and only those subset of N−1 target concepts where any of the Z attribute values (e.g., the F, C and A values) are positive are included as target concepts in the source concept's Knowlet.

In the aspect of the present invention where step 312 includes the steps of calculating the F, C and A attributes (or values) for each concept pair, the F value may be determined, for example, by factual relationships between two concepts as determined by analyzing the data store. In one aspect of the present invention, <noun> <verb> <noun> (or <concept> <relation> <concept>) triplets are examined to deduce factual relationships (e.g., “malaria”, “transmitted” and “mosquitoes”). Thus the F value may be, for example, either zero (no factual relationship) or one (there is a factual relationship), depending on the search of the one or more data stores loaded in step 304.

Although the factual F value is zero or one, in one aspect of the present invention, it will be recognized by those of ordinary skill in the art that the factual attribute F may be influenced by taking into account one or more weighting factors, such as the semantic type(s) of the concepts, for example, as defined in the thesaurus. For example, a more meaningful relationship is presented by <gene> and <disease>, than by <gene> and <pencil>, which may in turn influence the F value. In this example, the F value is determined by the existence (or non-existence) of factual relationships in authoritative data sources accepted by the scientific community in a given area, such as PubMed. However, it will be apparent to those of ordinary skill in the art that the F value is not an indication of the veracity or authenticity of the concept or relationship, and that it may be determined based on other factors. Further, repetition of facts is of great value for the readability of individual text (e.g., articles) in the data store, but the fact itself is a single unit of information, and needs no repetition within the Knowlet space. There is an intuitive relationship between the level of repetition of facts in the “raw literature” of the data store and the likelihood that the fact is “true,” but even multiple repetitions do not guarantee that a fact is really true. Thus, in an aspect of the present invention, it is assumed that beyond a predefined threshold, further repetition of a fact does not increase the likelihood that the factual statement is true.

The C value is determined by the co-occurrence relationship between two concepts, determined by whether they appear within the same textual grouping (e.g., per sentence, per paragraph, or per x number of words). In one aspect of the present invention, the C value may range from zero to 0.5 based on the number of times a co-concurrence of the two concepts is found within the data store(s). A co-occurrence may be determined by taking into account one or more weighting factors, such as the semantic type(s) of the concepts in the data store. The C value may therefore be influenced by, for example, one or more weights. That is, if a <drug> and a <disease> both occur in the same textual grouping under consideration (e.g., a sentence), there is in fact a co-occurrence. If <drug> and <city>, however, both occur in the same sentence, a co-occurrence relationship is less likely indicated by the present invention, in accordance with one aspect.

The A value is determined by the associative relationship between two concepts. In one example, the A value may range from zero to 0.4 depending on the outcome of a multidimensional scaling process in a cluster of concepts (i.e., n-dimensional space), which explores similarities or dissimilarities in the data store between the two concepts. The A value is an indication of conceptual overlap between two concepts. In one example, the closer the two concepts are in the multidimensional cluster of concepts, the higher the associative value A between them will be. If there is little or no conceptual overlap, the associative value A will be closer to zero.

The indirect association between two concepts is calculated based upon the matching of their individual “concept profiles.” A concept profile is constructed as follows: For each concept found in the data store(s) loaded into system 100, a number of records are retrieved in which that specific concept has a significant incidence. In certain aspects, high precision may be favored at the expense of (IR) recall. A list is thus constructed such that concepts from minimally one, but up to a pre-defined threshold (e.g., 250), selected records within the data store (e.g., abstracts in PubMed) that are “about” that source concept. A ranked concept lists is then constructed by terminology-based, concept-indexing of the entire returned record (e.g., a PubMed abstract), followed by weighted aggregation into one list of concepts. The concepts in this list exhibit a high association with the source concept. These lists can now be expressed as vectors in multidimensional space and the associative score (A), for each of the vector pairs, is calculated. This associative score is recorded as a value between 0 and 1 in the A category of the Knowlet. Thus, even for those concepts between which the F and C parameters are negative, a positive association score A beyond a statistically defined threshold may indicate that there is significant conceptual overlap in their respective concept profiles to suggest an as yet non-explicit relationship. Thresholds can be calculated by comparing the distribution concept profile matches of non-related concepts of certain semantic types with those that are known to interact (e.g., all proteins that are not known to interact with those that are known to interact in Swiss-Prot and IntAct).

In an aspect of the present invention, in the case where neither F nor C is positive for a given pair of concepts, there may still be circumstantial evidence for a meaningful relationship between the concepts, even if the association is only implicit. Such associative connections are captured in the Knowlet as the third parameter, A. In one aspect of the invention, the A parameter represents the most interesting aspect of the Knowlet (e.g., while using system 100 in a “discovery” mode as detailed below). As facts are moved from a C+ and F− state to an F+ state, the data store(s) loaded into system 100 become more factually solidified. However, bringing a concept combination from a F−, C− and A+ state to an F+ state will either yield new co-occurrences and facts missed so far or, more importantly, may in fact be part of the knowledge discovery process by in silico reasoning (and potentially, later laboratory-related experiments to confirm literature based hypotheses).

As will be appreciated by those skilled in the relevant art(s) after reading the description herein, steps 304-312 may be periodically repeated so as to capture updates to the data store(s) (e.g., new abstracts in PubMed) and/or ontology(ies) (i.e., new concepts).

In one aspect of the present invention, step 314 receives a search query from a user consisting of one or more source concepts (i.e., a selected concept taken as the starting point for knowledge navigation and discovery within the concept space).

In one aspect of the present invention, step 316 performs a lookup in the Knowlet space and calculates a semantic distance (SD) for all N−1 potential target concepts relative to the source concept, and produces a set of target concepts (i.e., concepts in the concept space that have a relation to the source concept). In one aspect, for example, the system would return a set of target concepts corresponding to the 50 highest SD values calculated within the Knowlet space.

In such an aspect, the semantic distance may be calculated:

SD=w₁F+w₂C+w₃A;

where w₁, w₂ and w₃ are weights assigned to the F, C and A values, respectively. As will be appreciated by those skilled in the relevant art(s) after reading the description herein, users may be able to query the system in different modes which would then automatically adjust the w₁, w₂ and w₃ values. For example, in a “background” mode where the user simply wants factual, background information, w₁, w₂ and w₃ may be set to 1.0, 0.0 and 0.0, respectively. In another example, in a “discovery” mode where the user simply wants to highlight associative relationships, w₁, w₂ and w₃ may be set to 1.0, 0.5 and 2.0, respectively. In other aspects of the present invention, the F, C and A values may be weighted by different factors or characteristics (e.g., by semantic type) in different modes. Thus, the SD (or semantic association) is the computed semantic relationship between a source concept and a target concept based on weighted factual, co-occurrence and associative information.

In one aspect of the present invention, step 318 presents the target concepts to the user via GUI such that the user may view the source concept, the set of target concepts (color coded according to F, C, A and/or SD values) and the list of records within the data store(s) (i.e., the PubMed abstracts) which form the basis of the relationships for the SD calculations. Process 300 then terminates as indicated by step 320.

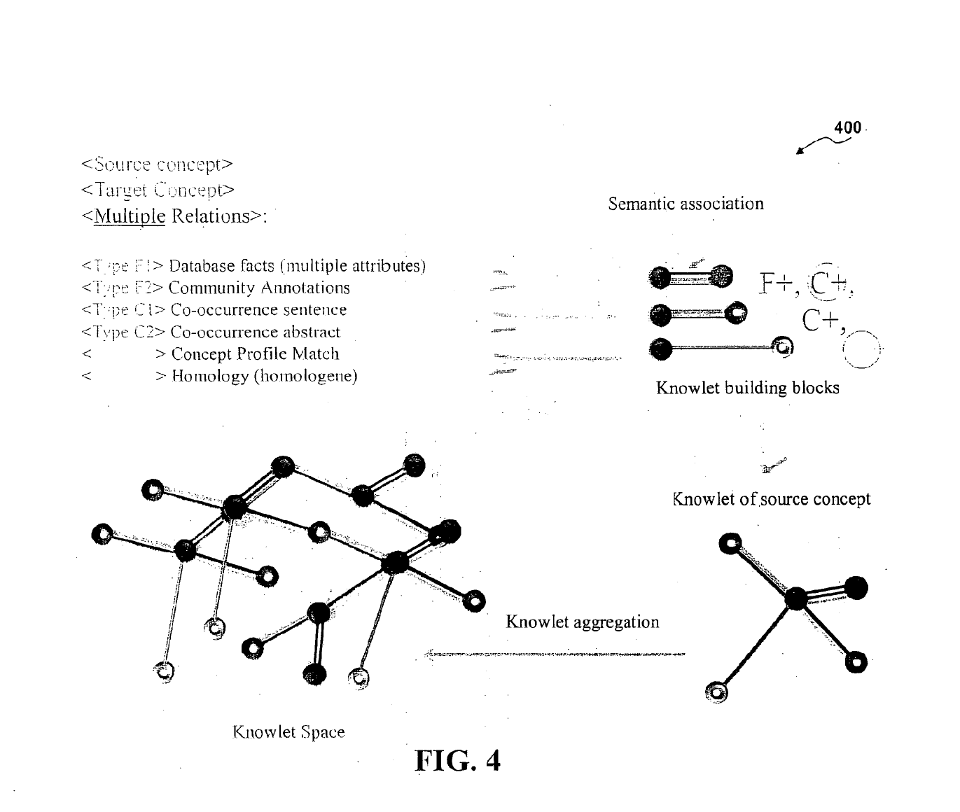

Referring to FIG. 4, a block diagram depicting an exemplary composition of a Knowlet data structure 400, as produced by process 300, according to an aspect of the present invention is shown.

In an aspect of the present invention where the an automated tool is provided to users, such as biomedical research scientists, to allow them to navigate, search and perform knowledge discovery, any concept in the biomedical literature, for instance a protein or a disease, can be treated as a source concept (depicted as a blue ball in FIG. 4). There may be curated information in authoritative databases such as UMLS or UniProtKB/Swiss-Prot concerning the concept and its factual relationships with other concepts. This information is captured and all concepts that have a “factual” relationship with the source concept in any of the participating databases are thus included in the Knowlet of that concept. These “factually associated concepts” are depicted in the Knowlet visualization as solid green balls in FIG. 4.

In addition, the source concept may be mentioned with other concepts in one and the same sentence in the literature. In that case, especially when there are multiple sentences in which the two concepts co-occur, there is a high chance for a meaningful, or even causal, relationship between the two concepts. Most concepts that have a factual relationship are likely to be mentioned in one or more sentences in the literature at large, but as process 300 may have only mined one data store (e.g., PubMed), there might be many factual associations that are not easy to recover from such data store alone. For instance, many protein-protein interactions described in UniProtKB/Swiss-Prot cannot be found as co-occurrences in PubMed. Target concepts which co-occur minimally once in the same sentence as the source concept, are depicted as green rings in the visualization of the Knowlet in FIG. 4.

The last category of concepts is formed by those that have no co-occurrence per unit of text (e.g., a sentence) in the indexed records of the data store, but have sufficient concepts in common with the source concepts in their own Knowlet to be of potential interest. These concepts are depicted as yellow rings in FIG. 4 and could represent implicit associations. Each source concept has a relationship of varying strength with other (target) concepts and each of these distances has been assigned with a value for Factual (F), Co-occurrence (C) and Associative (A) factors. The semantic association (or SD value) between each concept pair is computed based on these values.

In another aspect of the present invention, the user may enter two or more source concepts. In such an aspect, the system produces a set of target concepts which relate to all of the source concepts entered. As will be appreciated by those skilled in the relevant art(s) after reading the description herein, such an aspect may serve as a better IR or search engine. That is, source concepts A and B may have no factual (F) or co-occurrence (C) relationships in the one or more data store(s) loaded into the system in step 304. Thus, a traditional search engine may yield no results while performing a traditional Boolean/keyword search. Utilizing the Knowlet space, however, the present invention is able to produce target concepts which associatively (A) link the source concepts A and B.

In another aspect of the present invention, steps 308 and 310 described above can be augmented by also indexing the authors of the records in the data store (i.e., the authors of the publications whose abstracts appear in PubMed). In such an aspect of the present invention, not only are the N concepts mapped to each other in the Knowlet space, but also the universe of M authors are uniquely mapped to the N concepts such that the Knowlet space is now a [N+M]×[N+M−1]×3 matrix (i.e., a concept space where each concept has a Knowlet and each author has a Knowlet). As will be appreciated by those skilled in the relevant art(s) after reading the description herein, such an aspect would allow users to easily identify experts related to particular concepts for collaborative research purposes.

As will be appreciated by those skilled in the relevant art(s) after reading the description herein, in aspects of the present invention where the universe of M authors are uniquely mapped to the N concepts such that the Knowlet space is a [N+M]×[N+M−1]×3 matrix (provided the number of Z attributes is three), many useful tools can be presented to users of system 100. In one such aspect, various contribution factors may be calculated for each of the M authors who appear in the data store(s) loaded into the system in step 304. The contribution factors would distinguish between those authors who were simply prolific (i.e., had a large number of publications) and those who were “innovative” (i.e., those authors whose works were responsible for two concepts co-occurring for the first time within the Knowlet space). As will be appreciated by those skilled in the relevant art(s) after reading the description herein, contribution factors may be calculated in a number of ways given the Knowlet space and the F, C and A parameters stored therein (e.g., the contribution factor may be based upon a per sentence, per article, or other basis). Contribution factors may also be calculated based on a sentence, sentences, an abstract or document, or a publication in general.

In another aspect of the present invention, as will be appreciated by those skilled in the relevant art(s) after reading the description herein, any images found within the data store(s) loaded into the system in step 304 (e.g., images found within articles in the data store) or images found in any other repository of images, may be associated with any of the N concepts during step 308. These images would then be indexed and referenced within the Knowlet space and utilized as another data point (or field) upon which the tool to navigate, search and perform discovery activities described herein may operate.

In another aspect of the present invention, as will be appreciated by those skilled in the relevant art(s) after reading the description herein, two separate Knowlet (or concept) spaces resulting from parallel set of steps 304-312 described above may be compared and searched to aid in the knowledge navigation and discovery process. That is, a Knowlet space created using a database and ontology from a first field of study may be compared to a second Knowlet space created using a database and ontology from a second (e.g., related) field of study. In one aspect, if a query in one ontology or resource fails to yield results, the present invention may provide an indication, based on the Knowlet space, that one or more relevant results may be found in the Knowlet space derived from another ontology or thesaurus.

In other aspects of the present invention, the tool to navigate, search and perform discovery activities may be provided in an enterprise fashion for use by an authorized set of users (e.g., research scientists within the R&D department of a for-profit entity, research scientists within a university, and the like). In such an aspect, the one or more (public) data stores loaded into the system can be augmented by one or more proprietary data stores (e.g., internal, unpublished R&D) and/or the one or more (public) ontologies or thesauri loaded into the system can be augmented by one or more proprietary ontologies or thesauri. In such an aspect, the combination of public and private data allows for a more complete (and, if desired, proprietary) concept space and thus more knowledge navigation and discovery capabilities. In such an aspect, the one or more private data stores loaded into the system may be unpublished articles by authors within the enterprise. This would allow users within the enterprise, for example, to capture and recognize, for example, new co-occurrences within the Knowlet space before the publication goes to print.

In other aspects of the present invention, the tool to navigate, search and perform discovery activities may offer users one or more security options. For example, in one aspect of the present invention, a Knowlet space created through the use of one or more proprietary data stores (e.g., internal, unpublished R&D) and/or one or more proprietary ontologies or thesauri may be stored within system 100 in an encrypted manner during step 312. In such an aspect of the present invention, as will be appreciated by those skilled in the relevant art(s), an encryption process may be applied to the Knowlet space such that only those with a decoding key (i.e., authorized users) may decrypt the Knowlet space.

In another aspect of the present invention, the tool for navigating, searching and performing knowledge discoveries may be used to select and/or categorize the output of Internet search engines “on the fly.” For example, the output of the search engine may be sorted and categorized, by URL, into folders in a data repository, for example, within the plug-in itself. On the basis of the documents stored in such folders and/or on the basis of concepts that have been accepted as text, the present invention, in one aspect, may create a user's interest profile.

As mentioned above, step 318 presents the target concepts to the user via a GUI such that the user may view the source concept, a wiki containing the definition of the source concept, and the set of target concepts. Thus, in aspects of the present invention, the user may edit the definition of the source concept in one or more of the displayed wikis (based on their observations of the target concepts and the list of records within the data store(s) which form the basis of the relationships for the SD calculations).

In another aspect of the present invention, where the tool to navigate, search and perform knowledge discovery is provided as an Internet browser plug-in or add-on, a button on a tool bar or pull-down menu may be provided to serve as a “newness indicator.” That is, as a user browses the Internet and comes across a Web page of interest, the user may click a “newness” button on a tool bar or pull-down menu provided by the present invention which would then parse through the HTML code of the active Web page “on the fly” and grey-out (e.g., show in grey) all the concepts found in the user's personal Knowlet space. In such an aspect, the user's attention would be directed to the text on the Web page which actually represents “new” knowledge with respect to the user (i.e., knowledge gained from documents already read by the user would appear in grey or any other desired color, which would be in contrast to the remaining text, the color or other attributes of which would not be modified).

In another aspect of the present invention, the tool to navigate, search and perform discovery activities may be provided via a proxy server such that a user's “favorite” or “bookmarked” Web sites are pre-parsed. In such an aspect, the user's browser would highlight (e.g., show in yellow) all the concepts found in the one or more ontologies or thesauri loaded in step 306 above without any manual intervention (i.e., without having to activate a “wikifier” button or menu option).

In other aspects of the present invention, the tool to navigate, search and perform knowledge discovery may be provided as a word processing/text editing plug-in or add-on. That is, as a user edits a wiki displayed along with the target concepts (as described above) or authors a new paper, the one or more ontologies or thesauri relevant the Knowlet space loaded into the system in step 306 above may be periodically consulted. Such a plug-in or add-on would recognize any of the N concepts as they are being typed by the user, and then make “on the fly” suggestions as to as synonyms, homonyms, translations and/or connected concepts thus functioning as a “Do you mean [list of n suggested concepts]?” tool. Further, the plug-in or add-on may allow displaying and/or changing the status of a concept in real time. For example, an indication may be provided regarding, among other factors, whether a concept of interest is appropriately defined and whether it is translated in one or more languages, thus providing an on-line “on the fly” concept status report.

### The Concept Web

In the relevant arts, “Web 1.0” refers to the state of the World Wide Web between approximately 1994 and 2004. Such state was a “read-only” state where most sites were one-way, published media (i.e., text and pictures). The term “Web 2.0” was coined circa 2004 (and which has very loosely defined boundaries) to refer to the evolution of the Web to a “read-and-write” state. That is, Web 2.0 reflects the Web-based communities and hosted services such as social-networking sites, wikis, blogs, and folksonomies, which aim to facilitate creativity, collaboration and sharing among users.

Now, aspects of the present invention facilitate a “semantic Web” (i.e., a Web 3.0 state) where a dynamic, interactive Web of concepts (or “Concept Web”) and their relationships derived from the World Wide Web and off-line resources, where both redundancy and ambiguity have been removed.

The first premise for the Concept Web is that a user/researcher performing an Internet search is not interested in data and information per se, but in a synthesis of these “building blocks” into executable knowledge upon which they can act. This premise holds, for example, when the user is looking for the “best hotel in Amsterdam,” all the way through to a highly complicated biological pathway. Such user is not interested in all information about all hotels in Amsterdam, nor can they read all 5000 scientific papers referring to all 50 genes in a hypothetical pathway. Instead, the user is really interested in making a decision where to stay in Amsterdam or which gene to postulate as causing a given disorder. The Concept Web, according to aspects of the present invention, enables just that desired outcome while reducing the interim need for reading and analyzing to a bare minimum, and without losing crucial information and trust.

Barriers to the Concept Web, however, include the problems of ambiguity and size. The “ambiguity problem” with respect to pages of text on the Internet (or any other data store) refers to the property of words, terms, notations, signs, symbols and concepts within a particular context as being undefined, indefinable, multi-defined or without an obvious definition, and thus having a misleading, or unclear, meaning. The “size problem” with respect to pages of text on the Internet (or any other data store) refers to the fact that most recent (2007) estimates of Web pages on the Internet are at 500 billion Web pages, spread over more than 100 million Web sites.

As will be appreciated by those skilled in the relevant art(s) after reading the description herein, the current state of the art is such that even highly ambiguous terms and tokens such as gene symbols with many meanings can be resolved by advanced disambiguation algorithms with a typical 80% precision at 80% recall. Therefore, aspects of the present invention may further include emerging disambiguation techniques to optimally reduce ambiguity.

As will be appreciated by those skilled in the relevant art(s) after reading the description herein, the “size problem” with respect to pages of text on the Internet (or any other data store) is created in part by redundancy. Taking scientific literature as representative of general published materials, the vast majority of sentences contain factual statements that have been stated minimally once before. In many cases, general facts are endlessly repeated to serve the readability of individual papers.

For example, it has been know for over a century that “Malaria” is “transmitted” by “Mosquitoes.” The PubMed bibliographic database (with over 17,000,000 abstracts), for example, contains 5618 instances of this co-occurrence. The added value of the over 5000 repetitions after the first ever statement is in the reconfirmation (and gradual solidification) of the stated fact and in the increase of the readability of the articles about malaria and its transmission and the dispersion of this fact in conjunction with other facts in individual documents. Utilizing Knowlets, in one aspect of the present invention, multiple attributes and values for relationships between concepts are combined such that scientific texts containing many reiterations of factual statements result in the relationships between two concepts being recorded only once. The attributes and values of the relationships change based on multiple instances of factual statements, increasing co-occurrence or associations. This approach results in a minimal growth of the Concept Web space as compared to the text space. Thus, in aspects of the present invention, a “zipping of the Web” (i.e., a compression) can be achieved.

As mentioned previously, two separate Knowlet (or concept) spaces resulting from parallel sets of steps 304-312 described above may be compared and searched to aid in the knowledge navigation and discovery process. That is, a Knowlet space created using a database and ontology from a first field of study may be compared to a second Knowlet space created using a database and ontology from a second field of study. Similarly, aspects of the present invention described above which result in a “zipping of the Web”, may be utilized to compare two or more zipped datasets at the concept level.

### Intellectual Networking

In the above discussion, an aspect of the present invention was disclosed where not only are the N concepts mapped to each other in the Knowlet space, but also the universe of M authors are uniquely mapped to the N concepts such that the Knowlet space is a [N+M]×[N+M−1]×3 matrix (i.e., a concept space where each concept has a Knowlet and each author has a Knowlet). As will be appreciated by those skilled in the relevant art(s) after reading the description above, such an aspect of the present invention allow users to easily identify experts related to particular concepts for collaborative research purposes.

In another aspect of the present invention, an intellectual networking site with additional functionality is provided to further assist in the knowledge navigation and discovery processes.

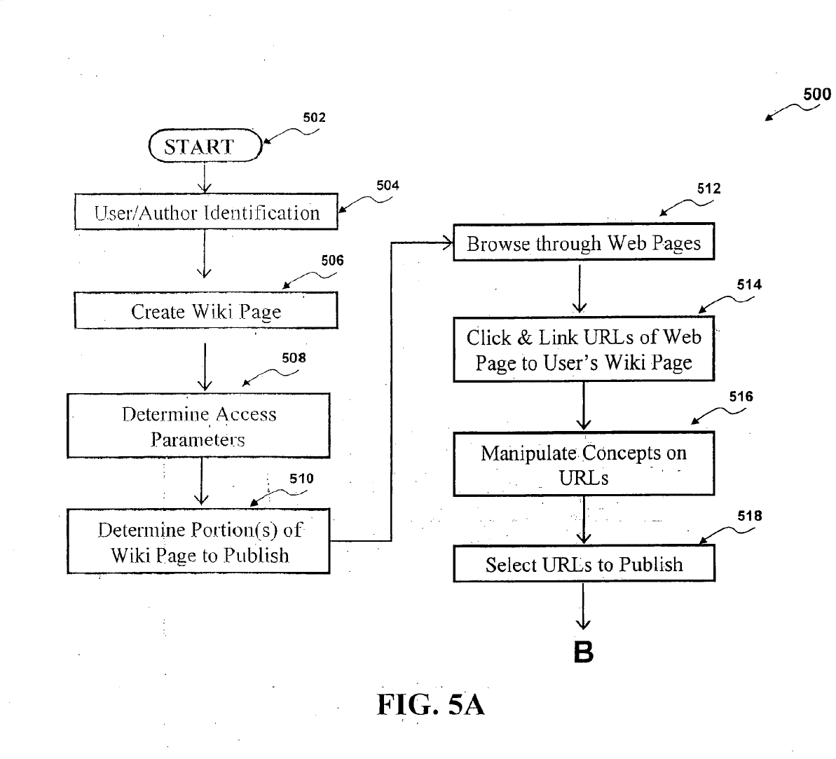

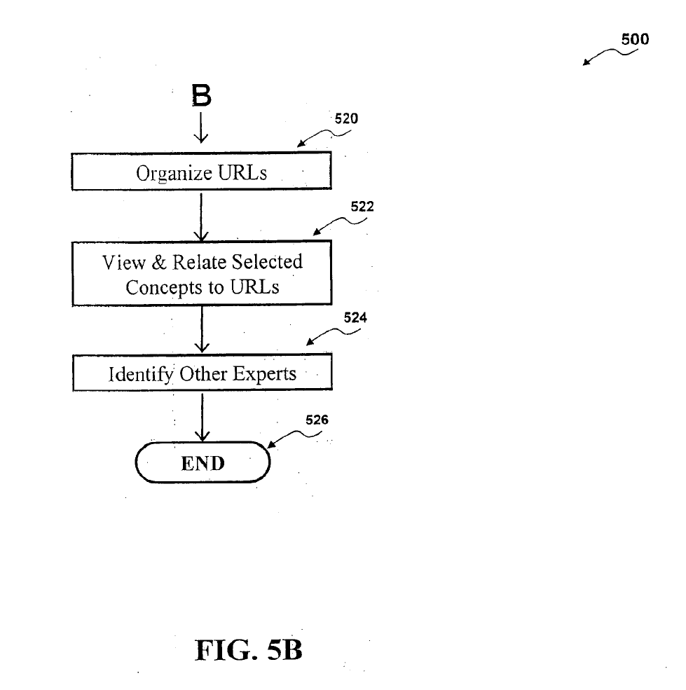

Referring to FIGS. 5A & 5B, flowcharts depicting an exemplary login and selection process 500 according to an aspect of the present invention are shown. Process 500 begins at step 502 with control passing immediately to step 504.

In such an aspect, each person within a field of interest (e.g., each of the M authors within the one or more data stores, for example, PubMed, as loaded into system 100 in step 304) is given a static, unique identifier—a WikiID in step 504. For each WikiID, a personal Web page (or “homepage”) is then created in step 506 within an intellectual networking Web site community. The homepage contains the author's (or expert's) name, including alternate spellings or common misspellings of their name, and curriculum vitae-related information (e.g., contact information, personal information, employment history, education, publications, professional qualifications, awards, professional memberships, conferences attended, interests, active projects, patents, and the like) and be accessible in an edit mode only to the expert or his/her designee (e.g., a personal assistant) via a login/password scheme as determined in step 508. Further, the expert, in step 510 would then be able to select which portion or portions of their homepage they want to “publish” (i.e., make available for browsing) to other experts on the intellectual networking Web site.

In such an aspect, the WikiID (and its link to each user's homepage) may be used for administrative purposes within the relevant intellectual networking community (e.g., registering for conferences, submitting papers, grant proposals and reports, etc.) obviating the need to manually fill out forms as is currently done for such activities.

In such an aspect—similar to the “wikifier” button described above where a user's browser would highlight (e.g., show in yellow) all the concepts from the one or more ontologies or thesauri loaded into system 100 in step 306 found on a Web page being browsed in step 512 without any manual intervention—a button is provided as an Internet browser plug-in or add-on such that the user can click the button to link (and post) in step 514 the URL of any page currently being browsed by them to their homepage on the intellectual networking Web site. In such an aspect the Internet browser plug-in or add-on button may be labeled a “Clink!” button (i.e., a combination of clicking and linking). The clink button would function not only to save (static) URLs of interests for the user related to concepts they are researching. Rather, clinking a URL also tags the concepts of interest to the user that appear on the page designated by the URL, thereby expanding the user's personal Knowlet space (i.e., expanding the knowledge base upon which the F, C and A attribute values can be calculated, besides the one or more data stores loaded into system 100 in step 304 of the above-described methodology).

Thus, the concepts appearing on the pages designated by the clinked URLs can then be manipulated in step 516 for knowledge discovery (e.g., background mode searching, discovery mode searching, etc.) as described above with concepts appearing in the documents within the one or more data store(s) loaded into system 100 (e.g., PubMed) in step 304 of process 300.

In such an aspect, users in step 520 may organize their “clinked” URLs on their homepage into folders or any other groupings, name each clinked URL and the like. Also, in such a concept, a user in step 522 can view their own homepage, highlight concepts (e.g., from their own curriculum vitae) they are interested in at the moment, and then have the clinked URLs related to the selected concept(s) appear, be highlighted or otherwise be distinguished from those URLs not related to the selected concept(s).

In such an aspect, users of the intellectual networking Web site community in step 524 may easily identify other experts related to particular concepts found on the clinked URLs by a user for collaborative research purposes. Process 500 then terminates as indicated by step 526.

As will be appreciated by those skilled in the relevant art(s) after reading the description herein, the intellectual networking Web site may take the form of a wiki site and thus allow collaborative efforts and other user/community features typically associated with wiki sites.

An aspect of the present invention discussed above may be utilized to create a “WikiPeople” intellectual networking site to facilitate knowledge navigation and discovery activities. In such an aspect, benefits of a WikiPeople site include: automatic alerts for literature based knowledge discovery; using the WikiID for funding, publishing and conferences; matching across all major languages on a user's curriculum vitae; and possibilities for job offerings, etc.

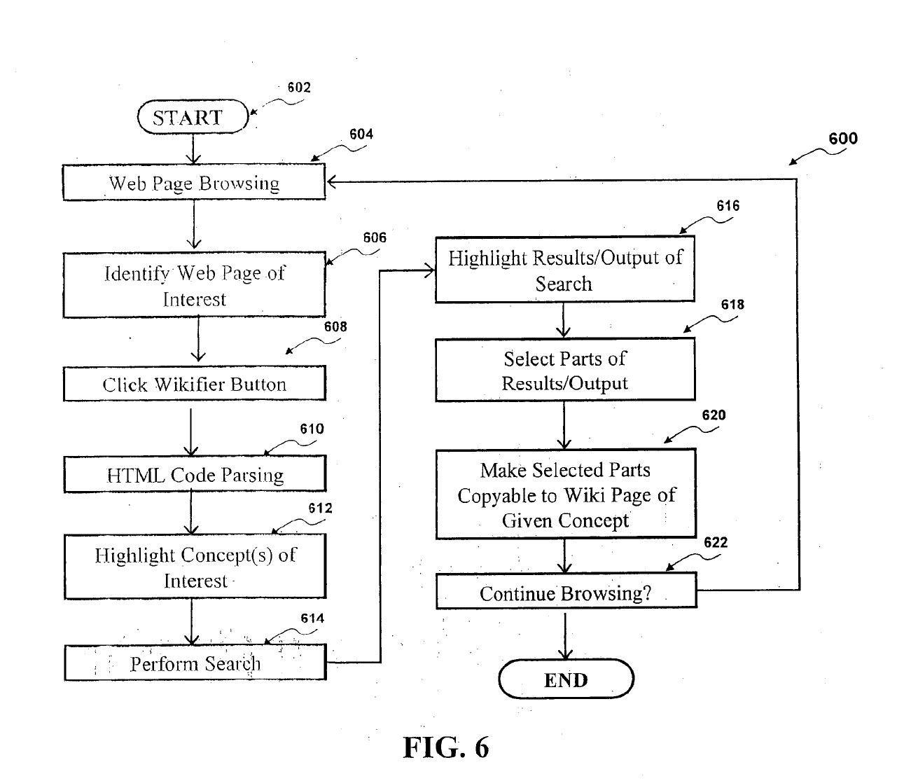

Referring to FIG. 6, a flowchart depicting a Wikifier process 600 for using the tool to navigate, search and perform knowledge discovery according to an aspect of the present invention is shown. This tool may be provided as an Internet browser plug-in or add-on. Process 600 begins at step 302 with control passing immediately to step 604.

As a user browses the Internet in step 604 and comes across a Web page of interest in step 606, the user may click a “wikifier” button in step 608 on a tool bar or pull-down menu provided by the present invention which would then parse through the HTML code of the active Web page “on the fly” in step 610 and highlight (e.g., show in color) in step 612 all the concepts found in the one or more ontologies or thesauri previously loaded in step 306 above into the system. This would allow the user to highlight one or more concepts of interests to perform a search in step 614 within the system of the present invention, using an Internet search engine such as Yahoo!, Google and the like, or even to perform a search within a specified wiki. An advantage of such an aspect of the present invention is that it builds more complex (and thorough) Internet search queries (i.e., Boolean “And” queries) than can ever be crafted by humans. This is due to the loaded ontologies or thesauri with its unique numerical identifier and synonyms (whether in the same language or in different languages).

As will be appreciated by those skilled in the relevant art(s), the “wikifier” button or menu option may be used on a Web page that itself represents the results (or output) of an Internet search engine, thus in step 616 highlighting “on the fly” all the concepts found in the one or more ontologies or thesauri previously loaded in step 306 into the system as described above. An entry regarding the highlighted concept may be made in the wiki. This entry may be edited later by the same or other users of the system. In such an aspect, the selected and edited wiki entry in step 618 may be the user's local copy or an enterprise's (i.e., community's) global copy. Further, in such an aspect, an on-the-fly “edit” button may be provided as part of the Internet browser plug-in or add-on such that it instantly in step 620 makes selected parts of the HTML output of a Web page “copyable” to a wiki page of a given concept, thus avoiding the need for massive importing of data from one Web site to another Web site. The result of this aspect of the present invention is to “federate” distributed sites (which may be in different natural languages) at the concept level and present them in a common GUI. (As will be appreciated by those skilled in the relevant art(s), “federating” refers to transforming a query and broadcasting it to a group of disparate databases, merging the results and presenting them in a succinct and unified format and allowing the results to be sorted.) The user is then presented in decision step 622 with the option of browsing further (in which case process 600 returns to step 604) or ending the session (as indicated by step 624).

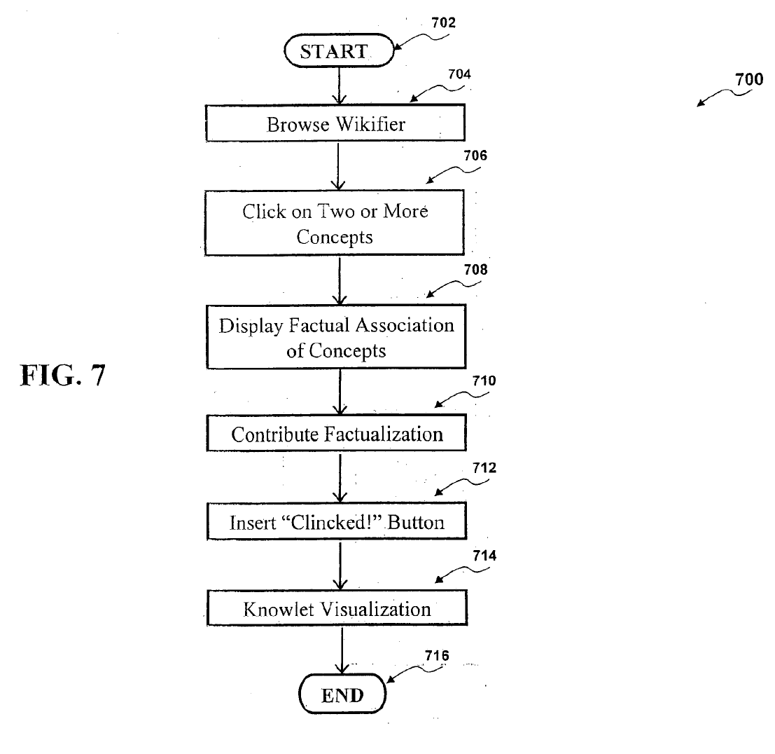

Referring to FIG. 7, a flowchart depicting a process 700 for utilizing the “Clinck!” functionality according to an aspect of the present invention is shown. Process 700 begins at step 702 with control passing immediately to step 704.

In this aspect, a feature of the “Clink!” button is that a user may first go to any page in the “wikifier” environment while browsing, as in step 704, and click two or more concepts in step 706 that are factually related in their opinion. The wikifier will then, in step 708, display in a pop up whether the concepts are already factually associated in the Concept Space or not. In case a user wishes in step 710 to contribute a “factualization” to the community, the user can just select the concepts in the text and press the “Clinck!” button. This action will result in the insertion of a “Clincked!” button in step 712 in each of the individual Wiki pages of the selected concepts. This will tell any subsequent user of those pages that the button contains a new link of that concept to another concept. It therefore serves as a collector of relationships to be annotated in the wiki. When any user has proposed a factual association between two concepts, it will be displayed in the Knowlet visualization as a “wiki” ball in step 714. Process 700 then terminates as indicated by step 720.

In such an aspect, modes for the Wikifier may include: and Exploration Mode: (current pop ups); a Tagging Mode: allows user to select tags, view selected tags, and store in an “Expert Profile,” “Interest Profile” or “Activity Profile”; a Translation Mode: (source language/target language) shows definitions in one or more languages available from a (drop-down); Clincking Mode: Prompts user to accept concepts in clincked pages displaying them as a ranked list (connected to Tagging mode); an Expert Location Mode: shows intellectual matches (can be used to find peers, reviewers, experts, etc.; and a Thesaurus Enrichment Mode: shows “others” by default and shows potential concepts in pages (simple NLP and bi-trigrams etc.).

In such an aspect, funders and publishers within the community may keep internal databases with more detailed information on users as reviewers, grantees, etc., which will be linked to each user's public WikiPeople homepage via their WikiID.

### The GUI

In other aspects of the present invention, the tool to navigate, search and perform discovery activities, may be provided to users to perform and provide a tool which allows a user to create, “on the fly,” a Web page connected to an editable environment, such as the Wiki.

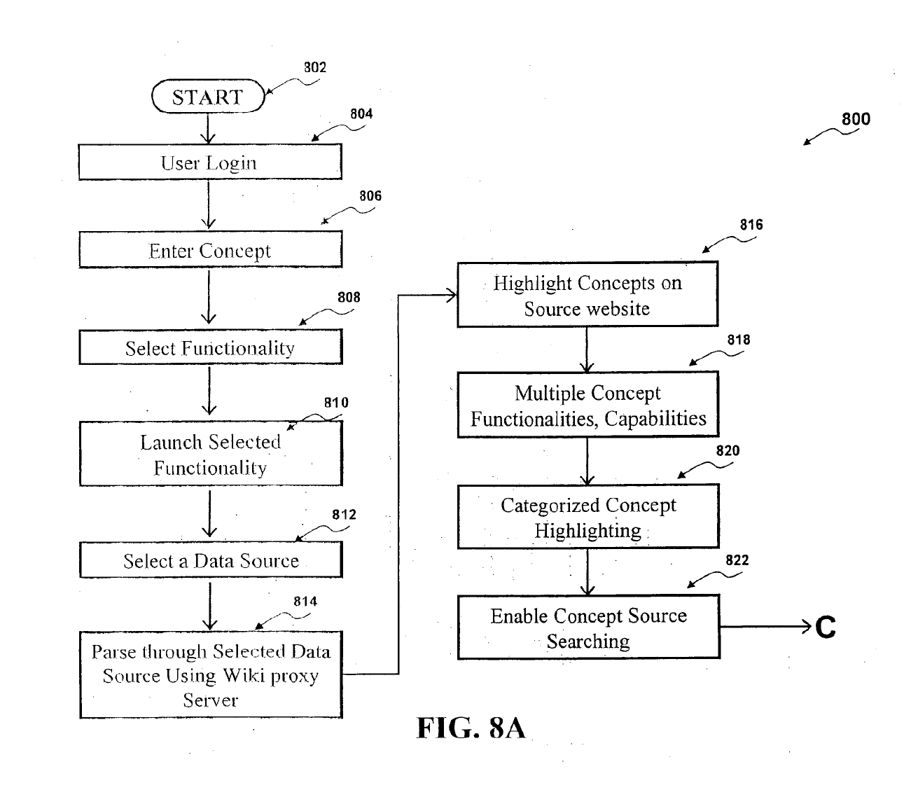

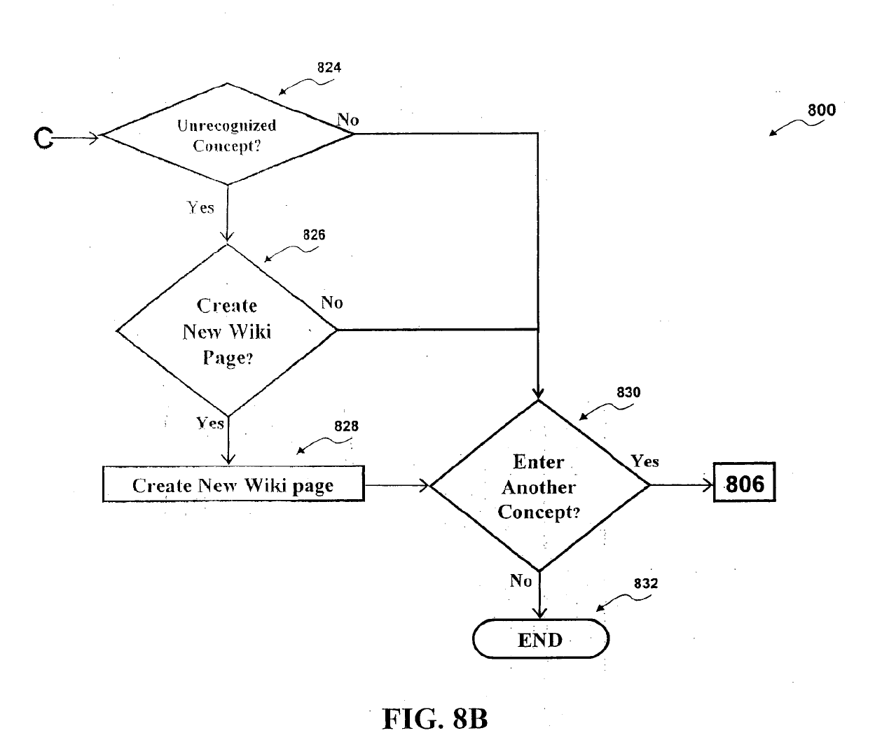

Referring to FIGS. 8A-8B, a flowchart depicting a process 800 for utilizing a Wikifier functionality according to an aspect of the present invention is shown. Process 800 begins at step 802 with control passing immediately to step 804.

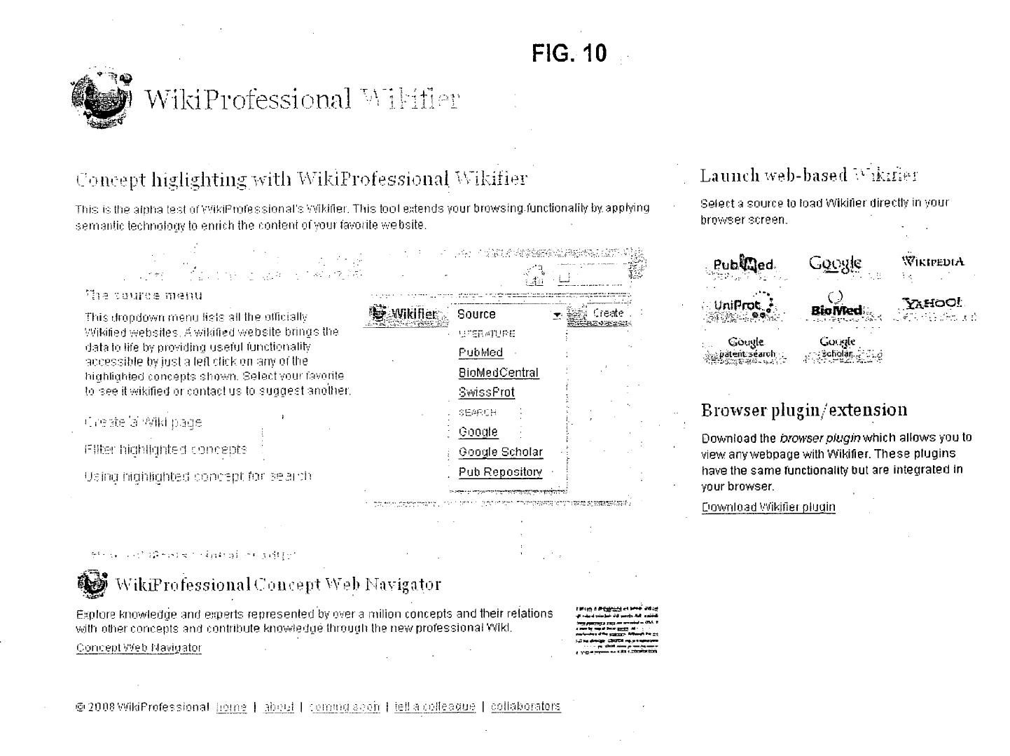

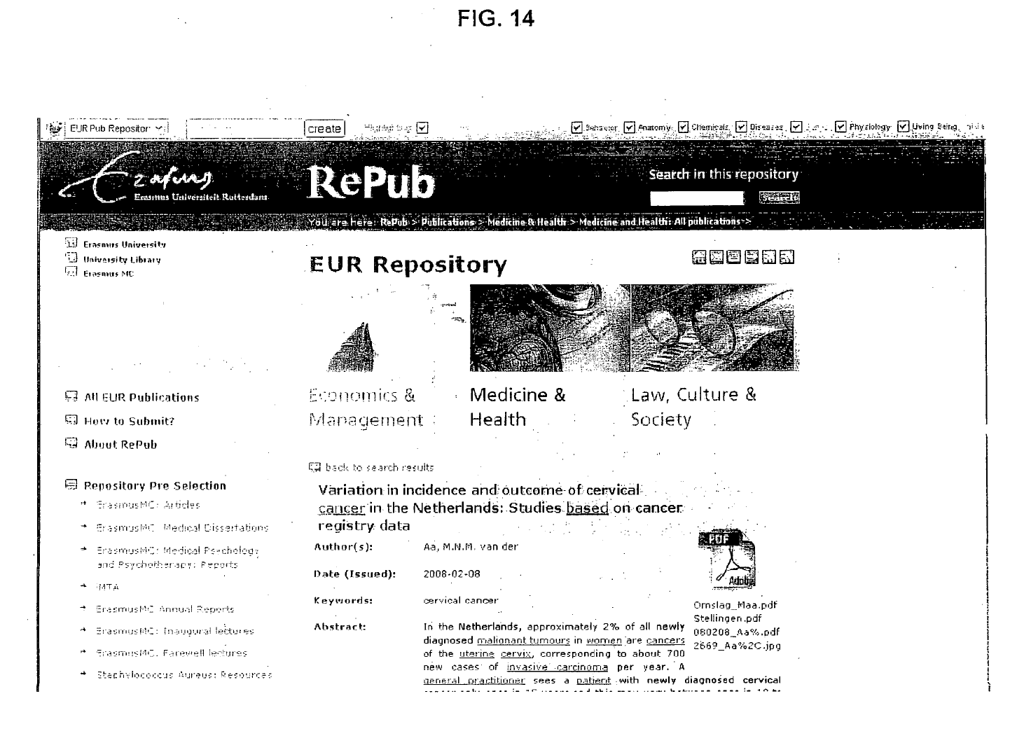

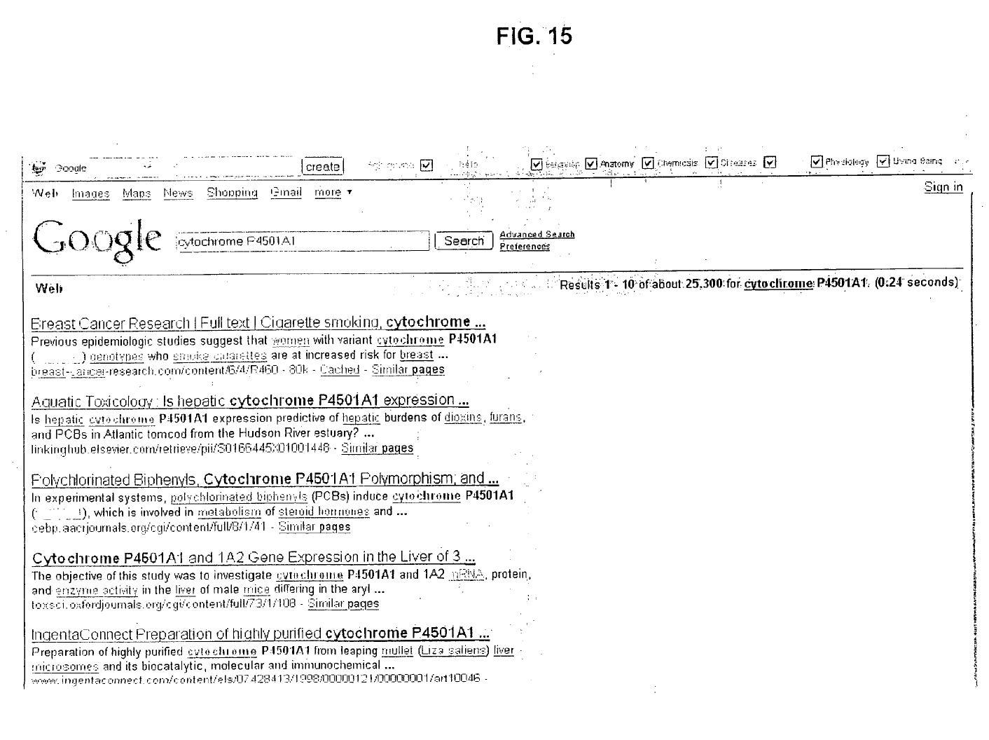

In such an aspect, a user logs on to the system or enters the concept web portal in step 804 and the GUI screen shown in FIG. 9 is displayed. The GUI screen of FIG. 9 will the user to enter a concept as shown in step 806. The user is also able to select the functionality (i.e., either Wikifier or the Concept Web Navigator) in step 808. After selecting the functionality, server 106 then launches the selected functionality in step 810 and the user is prompted to select a data source in step 812. The data source selection may be presented as a drop-down screen as shown in FIG. 10. Exemplary data sources shown include PubMed, BioMedCentral, Google, Google Scholar and Pub Repository. Once the user has selected the data source in step 812, the system according to the present invention then accesses and passes the selected data source in step 814 through the Wiki proxy server and then shows highlighted concepts on the data source web site in step 816. Exemplary displays are shown in FIGS. 15-22 for different data sources.

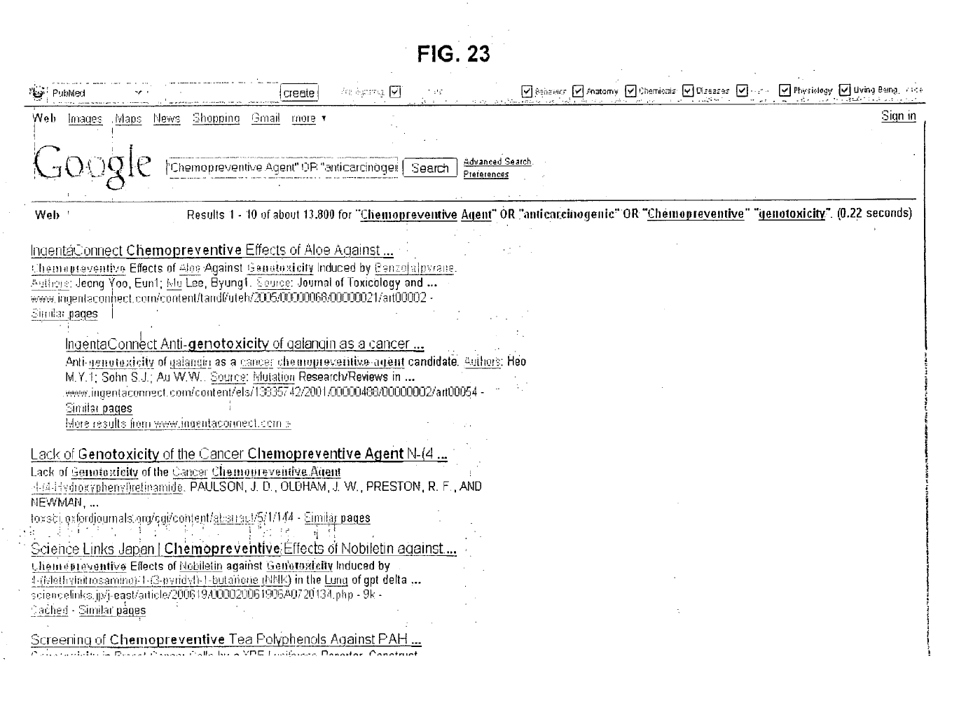

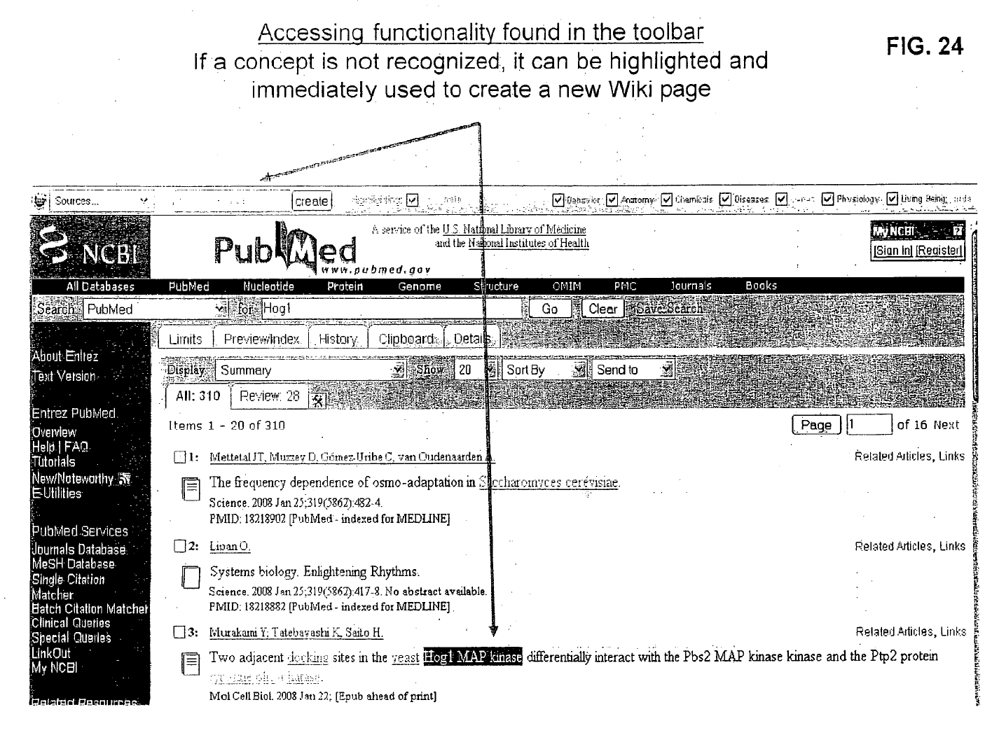

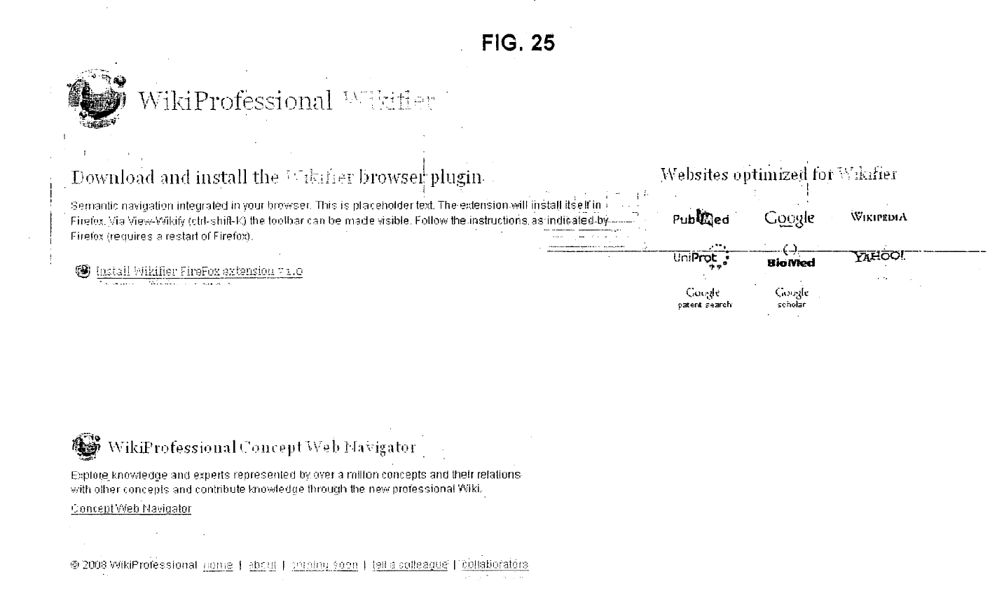

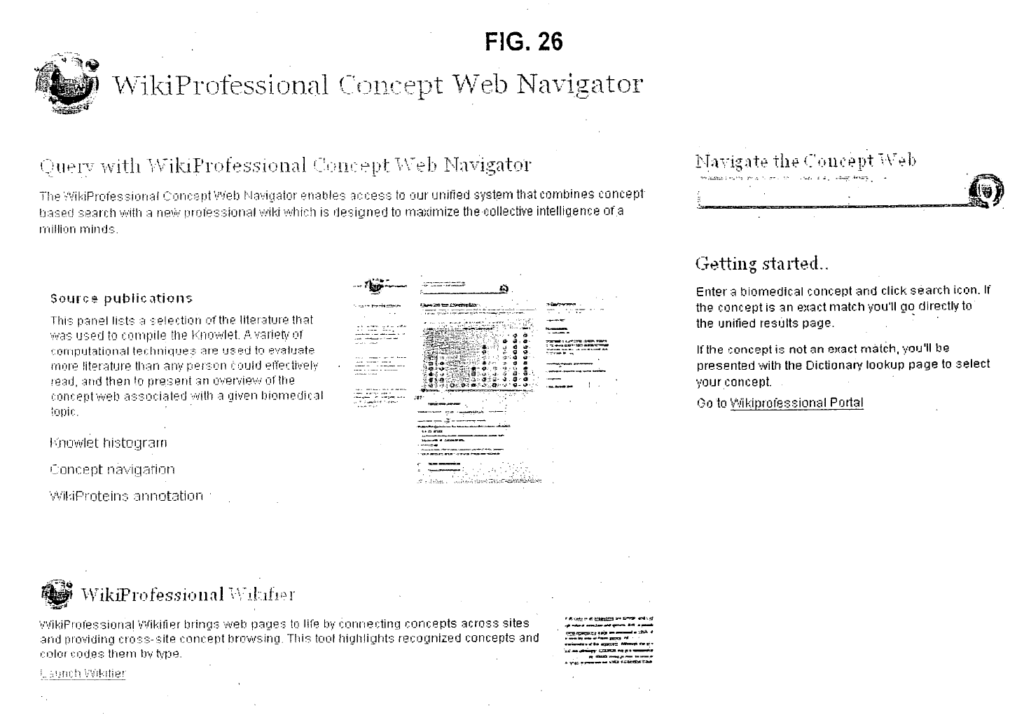

Next, the user may make use of different Wikifier search functionalities and capabilities in step 818, such as obtaining a definition of the concept, linking the concept to the concept web, obtaining methods for searching other websites with the concept, etc. as shown in FIG. 23. The user is further exposed to highlighting concept categories in step 820 and as displayed in FIG. 24 where the highlighted concepts will depend on the categories the user selects from the toolbar at the top of the browser as shown. The Wikifier search functionality when prompted in step 822 lists the query concepts and offers a list of sites available for searching as shown in FIG. 25. FIG. 26 shows an exemplary GUI screen displayed when Google is selected to be searched in step 822.

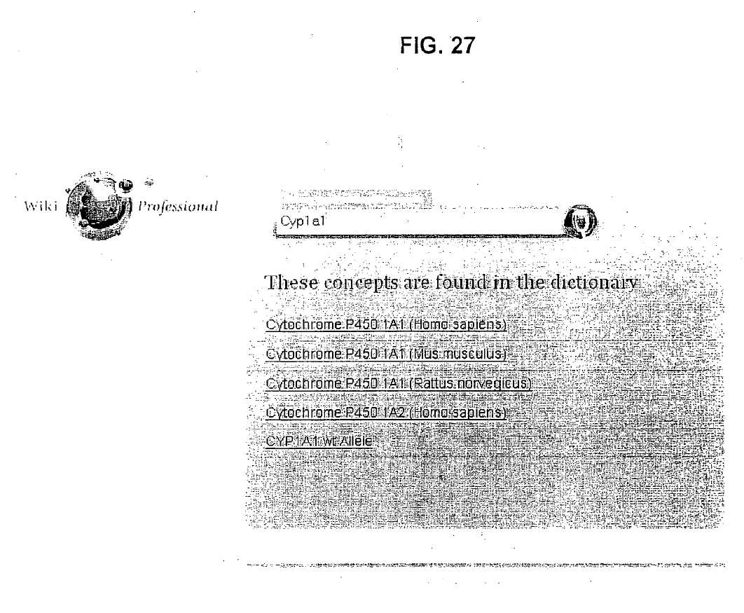

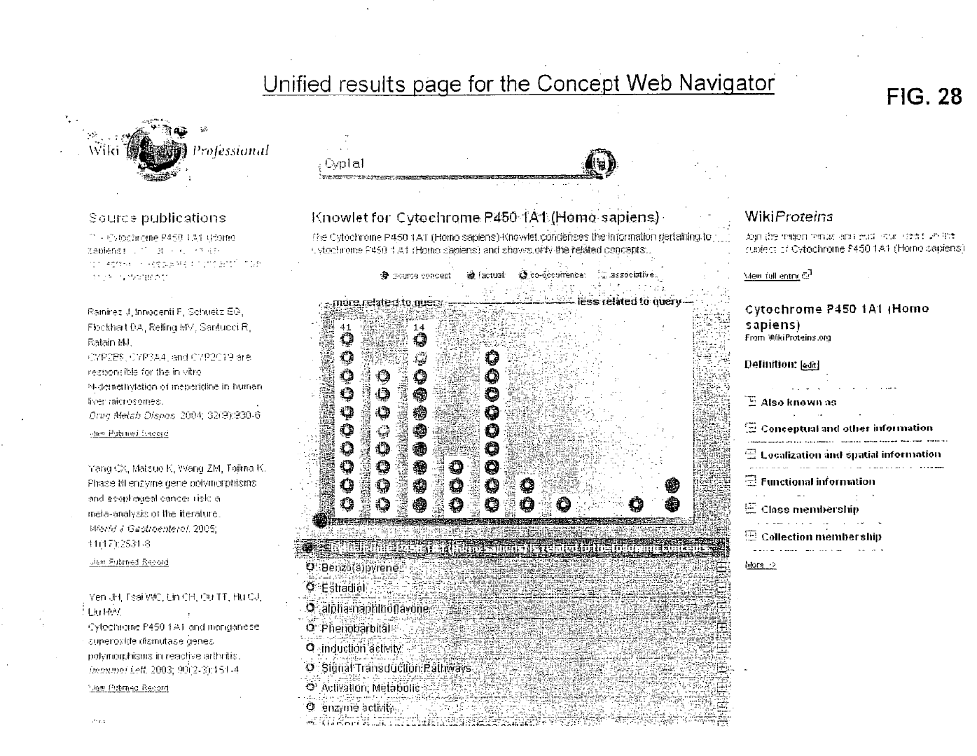

On adapted sites, as shown in FIG. 27, the query expansion may be used to refine the user's search, During the search, decision step 824 determines of the user encounters an unrecognized concept. If not, process 800 proceeds to step 830. If the user does encounter an unrecognized concept in step 824 (as shown in FIG. 28), the user is presented, in decision step 826, with the option of creating a new wiki page or just entering another concept. If the user chooses to enter another concept, process 800 returns to step 806. If the user decides to create a new wiki page, one is created in step 828 after which the user is presented with the option of entering another concept (step 830) or ending process 800 (as indicated by step 832).

### Example Implementation

Aspects of the present invention, the methodologies described herein or any part(s) or function(s) thereof) may be implemented using hardware, software or a combination thereof and may be implemented in one or more computer systems or other processing systems. However, the manipulations performed by the present invention were often referred to in terms, such as adding or comparing, which are commonly associated with mental operations performed by a human operator. No such capability of a human operator is necessary, or desirable in most cases, in any of the operations described herein which form part of the present invention. Rather, the operations are machine operations. Useful machines for performing the operation of the present invention include general purpose digital computers or similar devices.

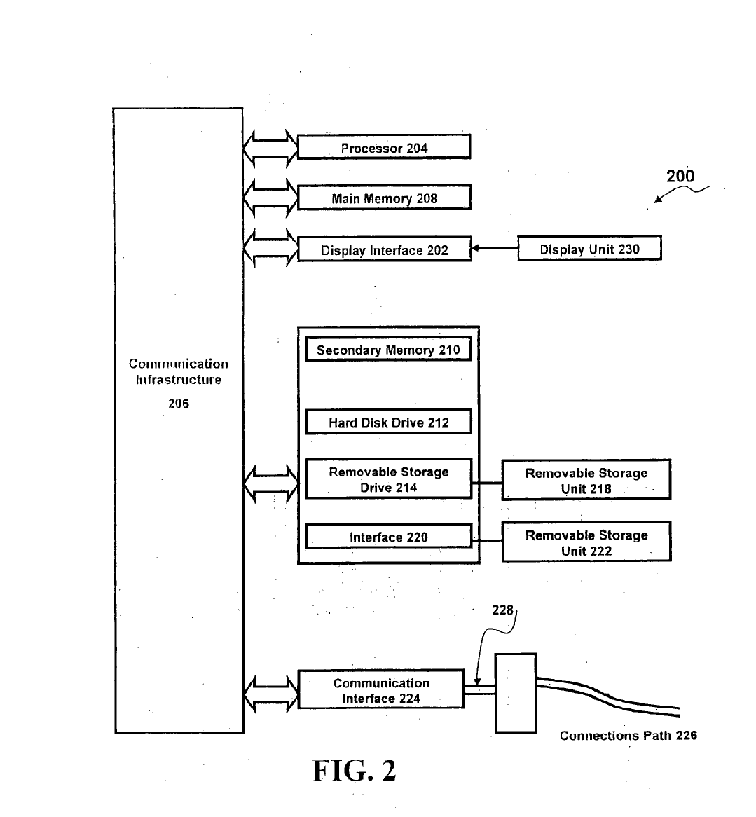

In fact, in one aspect, the invention is directed toward one or more computer systems capable of carrying out the functionality described herein. An example of a computer system 200 is shown in FIG. 2.

The computer system 200 includes one or more processors, such as processor 204. The processor 204 is connected to a communication infrastructure 206 (e.g., a communications bus, cross-over bar, or network). Various software aspects are described in terms of this exemplary computer system. After reading this description, it will become apparent to a person skilled in the relevant art(s) how to implement the invention using other computer systems and/or architectures.

Computer system 200 can include a display interface 202 that forwards graphics, text, and other data from the communication infrastructure 206 (or from a frame buffer not shown) for display on the display unit 230.

Computer system 200 also includes a main memory 208, preferably random access memory (RAM), and may also include a secondary memory 210. The secondary memory 210 may include, for example, a hard disk drive 212 and/or a removable storage drive 214, representing a floppy disk drive, a magnetic tape drive, an optical disk drive, etc. The removable storage drive 214 reads from and/or writes to a removable storage unit 218 in a well known manner. Removable storage unit 218 represents a floppy disk, magnetic tape, optical disk, etc. which is read by and written to by removable storage drive 214. As will be appreciated, the removable storage unit 218 includes a computer usable storage medium having stored therein computer software and/or data.

In alternative aspects, secondary memory 210 may include other similar devices for allowing computer programs or other instructions to be loaded into computer system 200. Such devices may include, for example, a removable storage unit 222 and an interface 220. Examples of such may include a program cartridge and cartridge interface (such as that found in video game devices), a removable memory chip (such as an erasable programmable read only memory (EPROM), or programmable read only memory (PROM)) and associated socket, and other removable storage units 222 and interfaces 220, which allow software and data to be transferred from the removable storage unit 222 to computer system 200.

Computer system 200 may also include a communications interface 224. Communications interface 224 allows software and data to be transferred between computer system 200 and external devices. Examples of communications interface 224 may include a modem, a network interface (such as an Ethernet card), a communications port, a Personal Computer Memory Card International Association (PCMCIA) slot and card, etc. Software and data transferred via communications interface 224 are in the form of signals 228 which may be electronic, electromagnetic, optical or other signals capable of being received by communications interface 224. These signals 228 are provided to communications interface 224 via a communications path (e.g., channel) 226. This channel 226 carries signals 228 and may be implemented using wire or cable, fiber optics, a telephone line, a cellular link, an radio frequency (RF) link and other communications channels.

In this document, the terms “computer program medium” and “computer usable medium” are used to generally refer to media such as removable storage drive 214, a hard disk installed in hard disk drive 212, and signals 228. These computer program products provide software to computer system 200. The invention is directed to such computer program products.

Computer programs (also referred to as computer control logic) are stored in main memory 208 and/or secondary memory 210. Computer programs may also be received via communications interface 224. Such computer programs, when executed, enable the computer system 200 to perform the features of the present invention, as discussed herein. In particular, the computer programs, when executed, enable the processor 204 to perform the features of the present invention. Accordingly, such computer programs represent controllers of the computer system 200.

In an aspect where the invention is implemented using software, the software may be stored in a computer program product and loaded into computer system 200 using removable storage drive 214, hard drive 212 or communications interface 224. The control logic (software), when executed by the processor 204, causes the processor 204 to perform the functions of the invention as described herein.

In another aspect, the invention is implemented primarily in hardware using, for example, hardware components such as application specific integrated circuits (ASICs). Implementation of the hardware state machine so as to perform the functions described herein will be apparent to persons skilled in the relevant art(s).

In yet another aspect, the invention is implemented using a combination of both hardware and software.

### CONCLUSION

While various aspects of the present invention have been described above, it should be understood that they have been presented by way of example, and not limitation. It will be apparent to persons skilled in the relevant art(s) that various changes in form and detail can be made therein without departing from the spirit and scope of the present invention. Thus, the present invention should not be limited by any of the above described exemplary aspects.

In addition, it should be understood that the figures and GUI screens illustrated in the attachments, which highlight the functionality and advantages of the present invention, are presented for example purposes only. The architecture of the present invention is sufficiently flexible and configurable, such that it may be utilized (and navigated) in ways other than that shown in the accompanying figures.

Further, the purpose of the foregoing Abstract is to enable the U.S. Patent and Trademark Office and the public generally, and especially the scientists, engineers and practitioners in the relevant art(s) who are not familiar with patent or legal terms or phraseology, to determine quickly from a cursory inspection the nature and essence of this technical disclosure. The Abstract is not intended to be limiting as to the scope of the present invention in any way.

### COMPUTER PROGRAM LISTING APPENDIX 1

Features and advantages of the present invention will become more apparent when the detailed description set forth above is read in conjunction with the attached computer program listing Appendix 1. Such portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

What is claimed is:

1. A method for facilitating knowledge navigation and discovery utilizing an intellectual networking site comprising:
a. identifying a user of said intellectual networking site;
b. creating a web page for said user within said intellectual networking site;
c. determining what portions of said user web page to publish on said intellectual networking site;
d. creating a link to the URL of a browsed web page containing concepts identified by said user; and
e. posting the URL of said browsed web page on said user's web page.

2. The method of claim 1, further comprising determining which URL to publish on said intellectual networking site.

3. The method of claim 1, further comprising creating a database of concepts for said user.

4. The method of claim 1, further comprising organizing said posted URLs.

5. The method of claim 1, further comprising highlighting posted URLs that relate to concepts identified by said user.

6. The method of claim 1, further comprising identifying individuals related to said identified concepts.

7. A method for facilitating knowledge navigation and discovery utilizing an intellectual networking site comprising:
a. loading at least one data store comprising a plurality of records related to a field of endeavor into a computer memory;
b. loading into said computer memory at least one thesauri, wherein said at least one thesauri contains an N number of concepts relevant to said field of endeavor;
c. parsing through the HTML code of an active web page;
d. highlighting at least one concept on said web page found in said at least one thesauri; and
e. copying sections of said HTML code containing said highlighted at least one concept to a wiki.

8. The method of claim 7, further comprising identifying at least one concept that is not within said at least one thesauri.

9. The method of claim 8, further comprising creating a wiki page for said at least one concept.

10. The method of claim 7, further comprising searching through said intellectual networking site based on said highlighted at least one concept.

11. The method of claim 7, further comprising searching through a selected wiki based on said highlighted at least one concept.

12. The method of claim 7, further comprising compiling information relating to said highlighted at least one concept within a database.

13. The method of claim 12, further comprising presenting said information in a unified format.

14. The method of claim 7, further comprising entering comments on said highlighted at least one concept.

15. The method of claim 14, further comprising editing comments on said highlighted at least one concept.

16. A method for facilitating knowledge navigation and discovery utilizing an intellectual networking site comprising:
a. selecting two or more concepts within a web page;
b. proposing a factual relationship between said concepts; and
c. creating a link between said concepts in each of the individual wiki pages of said concepts.

17. The method of claim 16, further comprising:
a. searching a database containing previously ascertained factual relationships; and
b. displaying a previously recorded factual relationship between said selected concepts.

18. The method of claim 16, further comprising displaying definitions of said selected concepts.

19. The method of claim 16, further comprising displaying said selected concepts in a ranked list.

20. The method of claim 16, further comprising locating individuals associated with said selected concepts.

21. The method of claim 16, further comprising posting said proposed factual relationship on said intellectual networking site.

22. A computer program product comprising a computer usable medium having control logic stored therein for causing a computer to facilitate knowledge navigation and discovery utilizing an intellectual networking site, said control logic comprising:
a. first computer readable program code means for causing the computer to identify a user of said intellectual networking site;
b. second computer readable program code means for causing the computer to create a web page for said user within said intellectual networking site;
c. third computer readable program code means for causing the computer to determine what portions of said user web page to publish on said intellectual networking site;
d. fourth computer readable program code means for causing the computer to create a link to the URL of a browsed web page containing concepts identified by said user; and
e. fifth computer readable program code means for causing the computer to post the URL of said browsed web page on said user's web page.

23. The computer program product of claim 22, further comprising sixth computer readable program code means for causing the computer to determine which URL to publish on said intellectual networking site.

24. The computer program product of claim 22, further comprising sixth computer readable program code means for causing the computer to create a database of concepts for said user.

25. The computer program product of claim 22, further comprising sixth computer readable program code means for causing the computer to organize said posted URLs.

26. The computer program product of claim 22, further comprising sixth computer readable program code means for causing the computer to highlight posted URLs that relate to concepts identified by said user.

27. The computer program product of claim 22, further comprising sixth computer readable program code means for causing the computer to identify individuals related to said identified concepts.

28. A computer program product comprising a computer usable medium having control logic stored therein for causing a computer to facilitate knowledge navigation and discovery utilizing an intellectual networking site, said control logic comprising:
a. first computer readable program code means for causing the computer to load at least one data store comprising a plurality of records related to a field of endeavor into a computer memory;
b. second computer readable program code means for causing the computer to load into said computer memory at least one thesauri, wherein said at least one thesauri contains an N number of concepts relevant to said field of endeavor;
c. third computer readable program code means for causing the computer to parse through the HTML code of an active web page;
d. fourth computer readable program code means for causing the computer to highlight at least one concept on said web page found in said at least one thesauri; and
e. fifth computer readable program code means for causing the computer to copy sections of said HTML code containing said highlighted at least one concept to a wiki.

29. The computer program product of claim 28, further comprising sixth computer readable program code means for causing the computer to identify at least one concept that is not within said at least one thesauri.

30. The computer program product of claim 29, further comprising seventh computer readable program code means for causing the computer to create a wiki page for said at least one concept.

31. The computer program product of claim 28, further comprising sixth computer readable program code means for causing the computer to search through said intellectual networking site based on said highlighted at least one concept.

32. The computer program product of claim 28, further comprising sixth computer readable program code means for causing the computer to search through a selected wiki based on said highlighted at least one concept.

33. The computer program product of claim 28, further comprising sixth computer readable program code means for causing the computer to compile information relating to said highlighted at least one concept within a database.

34. The computer program product of claim 33, further comprising seventh computer readable program code means for causing the computer to present said information in a unified format.

35. The computer program product of claim 28, further comprising sixth computer readable program code means for causing the computer to receive comments on said highlighted at least one concept.

36. The computer program product of claim 28, further comprising sixth computer readable program code means for causing the computer to enable the editing of comments on said highlighted at least one concept.

37. A computer program product comprising a computer usable medium having control logic stored therein for causing a computer to facilitate knowledge navigation and discovery utilizing an intellectual networking site, said control logic comprising:
a. first computer readable program code means for causing the computer to receive a selection of two or more concepts within a web page;
b. second computer readable program code means for causing the computer to receive a proposed factual relationship between said concepts; and
c. third computer readable program code means for causing the computer to create a link between said concepts in each of the individual wiki pages of said concepts.

38. The computer program product of claim 37, further comprising:
a. fourth computer readable program code means for causing the computer to search a database containing previously ascertained factual relationships between concepts; and
b. fifth computer readable program code means for causing the computer to display a previously recorded factual relationship between said selected concepts.

39. The computer program product of claim 37, further comprising fourth computer readable program code means for causing the computer to display definitions of said selected concepts.

40. The computer program product of claim 37, further comprising fourth computer readable program code means for causing the computer to display said selected concepts in a ranked list.

41. The computer program product of claim 37, further comprising fourth computer readable program code means for causing the computer to locate individuals associated with said selected concepts.

42. The computer program product of claim 37, further comprising fourth computer readable program code means for causing the computer to post said proposed factual relationship on said intellectual networking site.
